(19) United States
(12) Patent Application Publication
(10) Pub. No.: US 2026/0079722 A1
(43) Pub. Date: Mar. 19, 2026

(54) PROCESSING SYSTEM, RELATED INTEGRATED CIRCUIT, DEVICE AND METHOD

(71) Applicant: STMicroelectronics International N.V., Geneva (CH)

(72) Inventors: Luca Gandolfi, Milano (IT); Ugo Garozzo, Milano (IT)

(21) Appl. No.: 19/308,664

(22) Filed: Aug. 25, 2025

(30) Foreign Application Priority Data
Sep. 19, 2024 (IT) 102024000020890

(51) Int. Cl. G06F 9/445; G06F 9/448

(52) U.S. Cl. CPC G06F 9/44505; G06F 9/4498

(57) ABSTRACT

A co-processor comprises a plurality of processing circuits, a finite-state machine (FSM), a first memory, and a second memory. The first memory is configured to store control data, and the second memory comprises a memory area for storing a chain frame specifying a sequence of one or more processing operations, wherein the data associated with each processing operation comprise a code indicating one of the processing circuits and a configuration data frame comprising configuration data to be used for the processing operation. Specifically, the FSM is configured to determine whether the processing chain should be processed based on the control data, determine the code associated with a given processing operation indicated by a frame pointer, and enable the respective processing circuit. Conversely, the enabled processing circuit is configured to read the respective configuration data frame, and execute the respective processing operation.

### CROSS-REFERENCED TO RELATED APPLICATIONS

This application claims the priority benefit of Italian Patent Application No. 102024000020890, filed on Sep. 19, 2024, and entitled “Processing System, Related Integrated Circuit, Device and Method,” which is hereby incorporated herein by reference to the maximum extent allowable by law.

### TECHNICAL FIELD

Embodiments of the present disclosure relate to a processing method and circuit, such as co-processor of a processing system, such as a micro-controller or a Digital Signal Processor.

### BACKGROUND

FIG. 1 shows a typical electronic system, such as the electronic system of a vehicle, comprising a plurality of processing systems 10, such as embedded systems or integrated circuits, e.g., a Field Programmable Gate Array (FPGA), a Digital Signal Processor (DSP) or a micro-controller (e.g., dedicated to the automotive market).

For example, in FIG. 1 are shown three processing systems 101, 102 and 103 connected through a suitable communication system 20. For example, the communication system may include a vehicle control bus, such as a Controller Area Network (CAN) or Ethernet bus, and possibly a multimedia bus, such as a Media Oriented Systems Transport (MOST) bus, connected to the vehicle control bus via a gateway. Typically, the processing systems 10 are located at different positions of the vehicle and may include, e.g., an Engine Control Unit, a Transmission Control Unit (TCU), an Anti-lock Braking System (ABS), a Body Control Module (BCM), and/or a navigation and/or multimedia audio system. Accordingly, one or more of the processing systems 10 may also implement real-time control and regulation functions. These processing systems are usually identified as Electronic Control Units.

FIG. 2 shows a block diagram of an exemplary processing system 10, such as a micro-controller, which may be used as any of the processing systems 10 of FIG. 1.

In the example considered, the processing system 10 comprises a digital processing core 102. For example, the processing core 102 may comprise a microprocessor 102, usually the Central Processing Unit (CPU), programmed via software instructions. Usually, the software executed by the microprocessor 102 is stored in a non-volatile program memory 104, such as a Flash memory or EEPROM. Similarly, in case the processing core 102 comprises a FPGA, the programming data of the FPGA 102 may be stored to the non-volatile memory 104. Thus, the memory 104 is configured to store the firmware of the processing core 102, wherein the firmware may include the software instructions to be executed by a microprocessor 102 and/or the programming data of a FPGA, or other types of programmable logic circuits. Generally, the non-volatile memory 104 may also be used to store other data, such as configuration data, e.g., calibration data.

The processing core 102 usually has associated also a volatile memory 104b, such as a Random-Access-Memory (RAM). For example, the memory 104b may be used to store temporary data.

As shown in FIG. 2, usually the communication with the memories 104 and/or 104b is performed via one or more memory controllers 100. The memory controller(s) 100 may be integrated in the processing core 102 or connected to the processing core 102 via a communication channel, such as a system bus of the processing system 10. Similarly, the memories 104 and/or 104b may be integrated with the processing core 102 in a single integrated circuit, or the memories 104 and/or 104b may be in the form of a separate integrated circuit and connected to the processing core 102, e.g., via the traces of a printed circuit board.

In the example considered, the processing core 102 may have associated one or more (hardware) resources/peripherals 106 selected from the group of:
one or more communication interfaces IF, e.g., for exchanging data via the communication system 20, such as a Universal asynchronous receiver/transmitter (UART), Serial Peripheral Interface Bus (SPI), Inter-Integrated Circuit (I2C), Controller Area Network (CAN) bus, and/or Ethernet interface, and/or a debug interface; and/or
one or more analog-to-digital converters AD and/or digital-to-analog converters DA; and/or
one or more dedicated digital components DC, such as hardware timers and/or counters and/or co-processors; and/or
one or more analog components AC, such as comparators, sensors, such as a temperature sensor, etc.; and/or
one or more mixed signal components MSC, such as a PWM (Pulse-Width Modulation) driver.

Accordingly, the processing system 10 may support different functionalities. For example, the behavior of the processing core 102 is determined by the firmware stored in the memory 104, e.g., the software instructions to be executed by a microprocessor 102 of a micro-controller 10. Thus, by installing a different firmware, the same hardware (micro-controller) can be used for different applications.

In this respect, future generation of such processing systems 10, e.g., micro-controllers adapted to be used in automotive applications, are expected to exhibit an increase in complexity, mainly due to the increasing number of requested functionalities (new protocols, new features, etc.) and to the tight constraints of execution conditions (e.g., lower power consumption, increased calculation power and speed, etc.).

For example, recently more complex multi-core processing systems 10 have been proposed. For example, such multi-core processing systems may be used to execute (in parallel) several of the processing systems 10 shown in FIG. 1, such as several ECUs of a vehicle. Moreover, also more complex co-processors have been proposed. For example, such co-processors may support different functionalities and the specific operation to be executed may be programmable.

FIG. 3 shows a further example of a processing system 10, such as a multi-core processing system 10. Specifically, in the example considered, the processing system 10 comprises a plurality of n processing cores 102₁ . . . 102ₙ connected to a (on-chip) communication system 114. For example, in the context of real-time control systems, the processing cores 102₁ . . . 102ₙ may be ARM Cortex®-R52 cores. Generally, the communication system 114 may comprise one or more bus systems, e.g., based on the Advanced extensible Interface (AXI) bus architecture, and/or a Network-on-Chip (NoC).

For example, as shown at the example of the processing core 102₁, each processing core 102 may comprise a microprocessor 1020 and a communication interface 1022 configured to manage the communication between the microprocessor 1020 and the communication system 114. Typically, the interface 1022 is a master interface configured to forward a given (read or write) request from the microprocessor 1020 to the communication system 114, and forward an optional response from the communication system 114 to the microprocessor 1020. However, the communication interface 1022 may also comprise a slave interface. For example, in this way, a first microprocessor 1020 may send a request to a second microprocessor 1020 (via the communication interface 1022 of the first microprocessor, the communication system 114 and the communication interface 1022 of the second microprocessor). Generally, each processing core 102₁ . . . 102ₙ may also comprise further local resources, such as one or more local memories 1026, usually identified as Tightly Coupled Memory (TCM).

As mentioned before, typically the processing cores 102₁ . . . 102ₙ are arranged to exchange data with one or more non-volatile memory 104 and/or one or more volatile memory 104b. In a multi-core processing system 10, these memories are often system memories, i.e., shared for the processing cores 102₁ . . . 102ₙ. As mentioned before, each processing core 102₁ . . . 102ₙ may, however, comprise one or more additional local memories 1026. For example, as shown in FIG. 3, the processing system 10 may comprise one or more memory controllers 100 configured to connect at least one non-volatile memory 104 and at least one volatile memory 104b to the communication system 114.

As mentioned before, the processing system 10 may comprise one or more resources 106, such as one or more communication interfaces or co-processors. The resources 106 are usually connected to the communication system 114 via a respective communication interface 1062, such as a peripheral bridge. For example, for this purpose, the communication system 114 may indeed comprise an Advanced Microcontroller Bus Architecture (AMBA) High-performance Bus (AHB), and an Advanced Peripheral Bus (APB) used to connect the resources/peripherals 106 to the AMBA AHB bus. Usually, the communication interface 1062 comprises at least a slave interface. For example, in this way, a processing core 102 may send a request to a resource 106 and the resource returns given data. Generally, one or more of the communication interfaces 1062 may also comprise a respective master interface. For example, such a master interface, often identified as integrated Direct Memory Access (DMA) controller, may be useful in case the resource has to start a communication in order to exchange data via (read and/or write) request with another circuit connected to the communication system 114, such as another resource 106, a processing core 102 or a memory controller 100.

Often such processing systems 10 comprise also one or more general-purpose DMA controllers 110. For example, as shown in FIG. 3, a DMA controller 110 may be used to directly exchange data with a memory, e.g., the memory 104b, based on requests received from a resource 106. For example, in this way, a communication interface may directly read data (via the DMA controller 110) from the memory 104b and transmit these data, without having to exchange further data with a processing unit 102. Generally, a DMA controller 110 may communicate with the memory or memories via the communication system 114 or via one or more dedicated communication channels.

As mentioned before, the resources 106 may comprise a co-processor. Co-processors are known as such. For example, in this context may be cited documents US 2023/0315458A1, U.S. Pat. No. 10,372,507 B2, U.S. Pat. No. 7,249,351 B1, US 2009/0100200 A1, US 2019/0102671 A1 or US 2006/0200260 A1.

For example, FIG. 4 shows an example of a configurable co-processor 30. In the example considered, the co-processor 30 comprises a plurality of configuration registers 300 and at least one hardware processing circuit 302. In the example considered, the configuration registers 300 comprise a control register CTRL used to request a processing operation, a register DATA_IN for storing data to be processed (or a memory address where the data to be processed are stored) and a register DATA_OUT for storing the processed data (or a memory address where the processed data should be stored). Accordingly, once having requested a processing operation via the control register CTRL, the hardware processing circuit 302 (or a selected hardware processing circuit 302) may process the data stored to the register DATA_IN (or process the data stored to the memory address indicated by the register DATA_IN) and store the processed data to the register DATA_OUT (or store the processed data to the memory address indicated by the register DATA_OUT).

Specifically, in the example considered, at least one of the hardware processing circuits 302 is a configurable hardware processing circuit 302. For example, while FIG. 4 shows three processing circuits 302₁, 302₂ and 302₃, indeed not all of these processing circuits 302 may be configurable. Specifically, in this case, the configuration registers 300 comprises also a plurality of parameter registers P for storing configuration parameters for the configurable hardware processing circuits 302. For example, in this way, the processing core 102 may program the parameter registers P (and optionally the control register CTRL) of the co-processor 30 in order to configure the processing operation to be executed by the co-processor 30. Additionally or alternatively, at least part of the parameter registers P of the co-processor 30 may be programmed via a DMA controller configured to transfer the respective data from a memory, e.g., the memory 104, to the parameter registers P. For example, in this way, the co-processor 30 may be an artificial neural network co-processor, wherein the DMA controller transfers the parameters of the neural network to the co-processor 30. Next, the processing core 102 may write the control registers CTRL in order to request the execution of a processing via the co-processor 30. In this respect, the data to be processed by the co-processor may be provided by the processing core 102 and/or a DMA controller.

The solutions shown in FIG. 4 is well-known and suitable when the co-processor 30 has to execute always the same processing operation. In fact, each time the co-processor 30 has to be reconfigured, also the parameter registers P must be updated. For example, this implies that the co-processor 30 may hardly perform a sequence of different processing operations with the same configurable hardware processing circuit 302. For example, in case of a configurable hardware processing circuit 302 implementing a Finite Impulse Response (FIR) filter, the parameter registers P may be used to specify the filter parameters. For example, in this way, the configurable hardware processing circuit 302 may be configured as low-pass filter or high-pass filter. Accordingly, in order to apply a low-pass filtering and a high-pass filtering to given data, the processing system 10 (via the processing core 102 and/or a DMA controller) has to program the parameter register P for configuring the low-pass filter parameters, request the execution of the filter operation, re-program the parameter register P for configuring the high-pass filter parameters, and request a new execution of the filter operation. Accordingly, such a reprogramming of the parameter registers P is rather inefficient. In order to overcome the problem of reprogramming the parameter registers P, the co-processor 30 may comprise a plurality of identical hardware processing circuits 302, e.g., in order to implement the low-pass filter with a first hardware processing circuit 302 and the high-pass filter with a second hardware processing circuit 302. However, such a solution increases the cost of the co-processor 30.

### SUMMARY

In view of the above, it is an objective of various embodiments of the present disclosure to provide improved solutions for configurable co-processors.

According to one or more embodiments, one or more of the above objectives is achieved by means of a co-processor having the features specifically set forth in the claims that follow. Embodiments moreover concern a related processing system, integrated circuit, device and method.

The scope of protection is defined in the enclosed claims, which are an integral part of the technical teaching of the disclosure provided herein.

As mentioned before, various embodiments of the present disclosure relate to a co-processor comprising a plurality of processing circuits, wherein at least one processing circuit is configurable.

As mentioned before, various embodiments of the present disclosure relate to a co-processor. The co-processor comprises a plurality of processing circuits, a first memory, a second memory and a Finite-State Machine (FSM). The first memory is configured to store control data and the second memory comprises a memory area for storing a chain frame specifying a processing operation of a sequence of a plurality of processing operations, wherein each processing operation has associated data comprising a code indicating one of the processing circuits and a frame of configuration data comprising configuration data to be used for the processing operation. For example, the first memory and the second memory may be implemented with the same physical memory, or the first memory may be implemented with a register and the second memory may be implemented with a RAM.

In various embodiments, the FSM is configured to monitor the control data in order to determine whether the chain frame should be processed. In response to determining that the chain frame should be processed, the FSM obtains a chain start-address indicating the start address of the chain frame, and sets a frame pointer to the start-address of the chain frame. Next, the FSM reads a code from the first memory area based on the frame pointer and determines whether the code read from the first memory area corresponds to a code indicating one of the processing circuits. In response to determining that the code read from the first memory area corresponds to a code indicating one of the processing circuits, the FSM enables the processing circuit indicated by the code read from the first memory area.

In various embodiments, in response to being enabled, the enabled processing circuit is configured to read the configuration data of the frame of configuration data associated with the processing operation from the second memory, and executes a processing operation as a function of the configuration data read from the first memory area.

Specifically, in various embodiments, each processing operation has associated data comprising the code indicating one of the processing circuits followed by the frame of configuration data. In this case, the enabled processing circuit is configured to obtain the frame pointer indicating the position of the data associated with a processing operation within the second memory, and read the configuration data of the frame of configuration data associated with the processing operation from the second memory based on the frame pointer.

Moreover, in various embodiments, the enabled processing circuit increases the frame pointer to indicate the position of data associated with a next processing operation based on the length of the frame of configuration data. In fact, in this way, the FSM may read a next code and enable the respective processing circuit. For example, in various embodiments, the FSM is configured to read a code from the first memory area based on the frame pointer by reading the code from the memory location indicated by the frame pointer, and increasing the frame pointer to indicate the start of the following frame of configuration data. Accordingly, in this case, the enabled processing circuit may read the configuration data of the frame of configuration data associated with the processing operation from the first memory area based on the frame pointer by reading the configuration data of the frame of configuration data from the first memory area starting from the memory location indicated by the frame pointer.

Conversely, in order to indicate the next processing operation, the enabled processing circuit may set the frame pointer to the address of the last memory location of the frame of configuration data, and the FSM may increase the frame pointer by one prior to reading the next code. Alternatively, the enabled processing circuit may set the frame pointer to the address of the last memory location of the frame of configuration data plus one, whereby the FSM may directly ready the next code.

In other embodiments, each processing operation has associated data comprising the code indicating one of the processing circuits followed by a configuration frame pointer, which in turn indicates a memory address of the frame of configuration data. In this case, the enabled processing circuit may obtain the frame pointer indicating the position of the data associated with a processing operation within the second memory, read the configuration frame pointer associated with the processing operation from the second memory based on the frame pointer, and then read the configuration data of the frame of configuration data associated with the processing operation from the second memory based on the configuration frame pointer. Also in this case, the enabled processing circuit may increase the frame pointer to indicate the position of data associated with a next processing operation, e.g., by increasing the frame pointer by one. In various embodiments, the solutions may be combined, i.e., the frame of configuration data may follow the code and/or may be stored to a separate memory area.

In various embodiments, in response to having completed the processing operation, the enabled processing circuit signals the completion of the processing operation. In fact, in this case, the FSM may wait until the enabled processing circuit signals the completion of the processing operation before reading the next code.

In various embodiments, the chain frame may comprise data indicating a requested number of processing operations to be executed. Additionally or alternatively, the chain frame may end with a code indicating the end of the chain frame. For example, in this case, the FSM may determine whether the code read from the first memory area corresponds to a code indicating one of the processing circuits or the code indicating the end of the chain frame. For example, in response to determining that the code read from the first memory area corresponds to a code indicating one of the processing circuits, the FSM may read the next code once the enabled processing circuit signals the completion of the processing operation. Conversely, in response to determining that the code read from the first memory area corresponds to the code indicating the end of the chain frame, the FSM may signal the end of the processing of the chain frame.

In various embodiments, the chain start-address may be fixed or programmable. For example, in various embodiments, the second memory comprises a first memory area for storing a first chain frame and a second chain frame and a second memory area for storing a first start-address of the first chain frame and a second start-address of the second chain frame. In this case, the FSM may monitor the control data in order to determine whether the first chain frame or the second chain frame should be processed. Specifically, in response to determining that the first chain frame should be processed, the FSM reads the first start-address of the first chain frame from the second memory area and sets the frame pointer to the first start-address of the first chain frame. Conversely, in response to determining that the second chain frame should be processed, the FSM reads the second start-address of the second chain frame from the second memory area and sets the frame pointer to the second start-address of the second chain frame.

Alternatively, a second memory area may store a first mapping rule indicating whether a given chain frame should be processed, wherein the first mapping rule is followed by a start-address of the given chain frame corresponding to the first start-address of the first chain frame when the given chain frame corresponds to the first chain frame or the second start-address of the second chain frame when the given chain frame corresponds to the second chain frame. In this case, the FSM may read the first mapping rule from the second memory area and determine whether the first mapping rule and the control data indicate that the given chain frame should be processed. Accordingly, in response to determining that the given chain frame should be processed, the FSM reads the start-address of the given chain frame from the second memory area, and sets the frame pointer to the start-address of the given chain frame.

In various embodiments, the plurality of processing circuits comprise one or more digital processing circuits configured to process data stored to a first memory location indicated via a first address and store the processed data to a second memory location indicated via a second address, wherein the frame of configuration data read by the digital processing circuit comprises the first address and the second address. For example, the digital processing circuit may be configured to implement: a Fast Fourier Transform, a Finite-Impulse Response filter, an Artificial Neural Network or a cryptographic processing circuit.

In various embodiments, the plurality of processing circuits comprise one or more chain-modifier circuits configured to read a frame of configuration data comprising an address of a next code, and selectively set the frame pointer to the address of the next code. For example, the chain-modifier circuit may be configured to implement a down-sampling function, a delay function or a threshold comparison operation.

In various embodiments, the plurality of processing circuits comprise one or more support circuits configured to transfer data between the second memory and a memory external with respect to the co-processor, and/or send read and/or write request to a communication system, and/or request the execution of a given operation via a circuit external with respect to the co-processor and wait until the circuit signals the completion of the given operation.

Accordingly, in various embodiments, in order to correctly operate the co-processor of the present disclosure, a chain frame is stored to the first memory area of the second memory, wherein the chain frame specifies a processing operation or a sequence of a plurality of processing operations, wherein the data associated with each processing operation comprise a code indicating one of the processing circuits and a frame of configuration data comprising configuration data to be used for the processing operation. In various embodiments, the chain frame ends with a code indicating the end of the chain frame. Moreover, the control data are set to indicate that the chain frame should be processed by the co-processor.

Various embodiments also relate to a processing system, such as a microcontroller or DSP, comprising a processing core, the co-processor according to the present disclosure, and a communication system connecting the co-processor to the processing core.

### BRIEF DESCRIPTION OF THE DRAWINGS

Embodiments of the present disclosure will now be described with reference to the annexed drawings, which are provided purely by way of non-limiting example and in which:

FIG. 1 shows an example of an electronic system comprising a plurality of processing systems;

FIGS. 2 and 3 show examples of processing systems;

FIG. 4 shows an example of a co-processor adapted to be used in the processing systems of FIGS. 2 and 3;

FIG. 5 shows an embodiment of a co-processor according to the present disclosure;

FIGS. 6A, 6B, 6C and 6D show embodiments of the memory organization of the co-processor of FIG. 5;

FIG. 7 shows an embodiment of a processing chain stored to a memory of the co-processor;

FIG. 8 shows an embodiment of a plurality of processing chains stored to a memory of the co-processor;

FIG. 9 shows a further embodiment of a plurality of processing chains stored to a memory of the co-processor;

FIG. 10 shows an embodiment of the co-processor with a finite-state machine and a plurality of processing circuits;

FIG. 11 shows an embodiment of the operation of the finite-state machine of FIG. 10;

FIG. 12 shows an embodiment of a processing system, e.g., integrated in an integrated circuit, comprising the co-processor of FIG. 5 or 10;

FIGS. 13A, 13B, 13C and 13D show an embodiment of a digital processing circuit adapted to be used in the co-processor of the present disclosure;

FIGS. 14A, 14B, 14C and 14D show an embodiment of a down-sampling circuit adapted to be used in the co-processor of the present disclosure;

FIGS. 15A, 15B, 15C and 15D show an embodiment of a delay circuit adapted to be used in the co-processor of the present disclosure;

FIGS. 16A and 16B show an embodiment of a threshold comparison circuit adapted to be used in the co-processor of the present disclosure;

FIGS. 17A and 17B show an embodiment of a read request interface circuit adapted to be used in the co-processor of the present disclosure; and

FIG. 18 shows a further embodiment of a processing chain stored to a memory of the co-processor.

### DETAILED DESCRIPTION OF ILLUSTRATIVE EMBODIMENTS

In the following description, numerous specific details are given to provide a thorough understanding of embodiments. The embodiments can be practiced without one or several specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The references provided herein are for convenience only and do not interpret the scope or meaning of the embodiments.

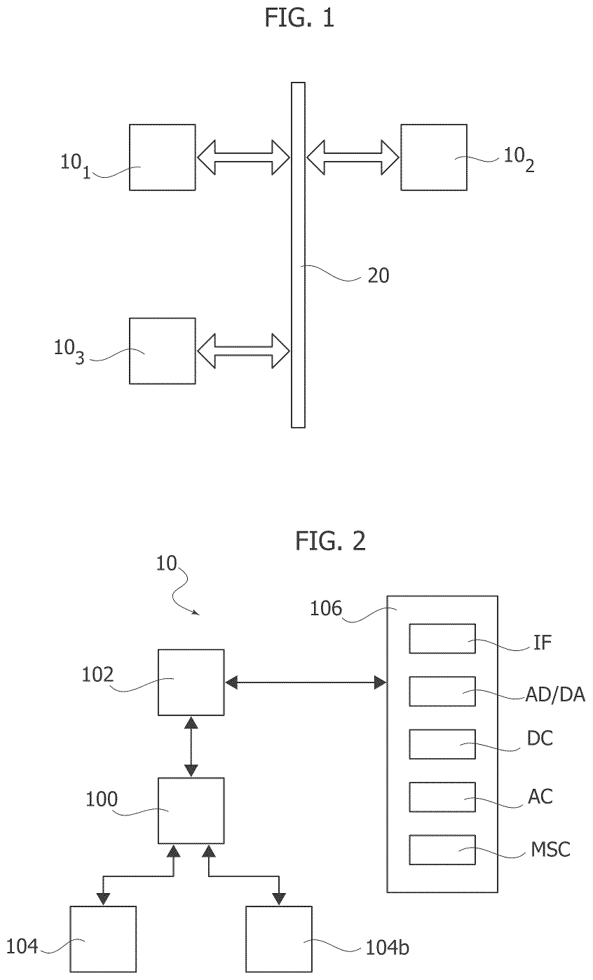

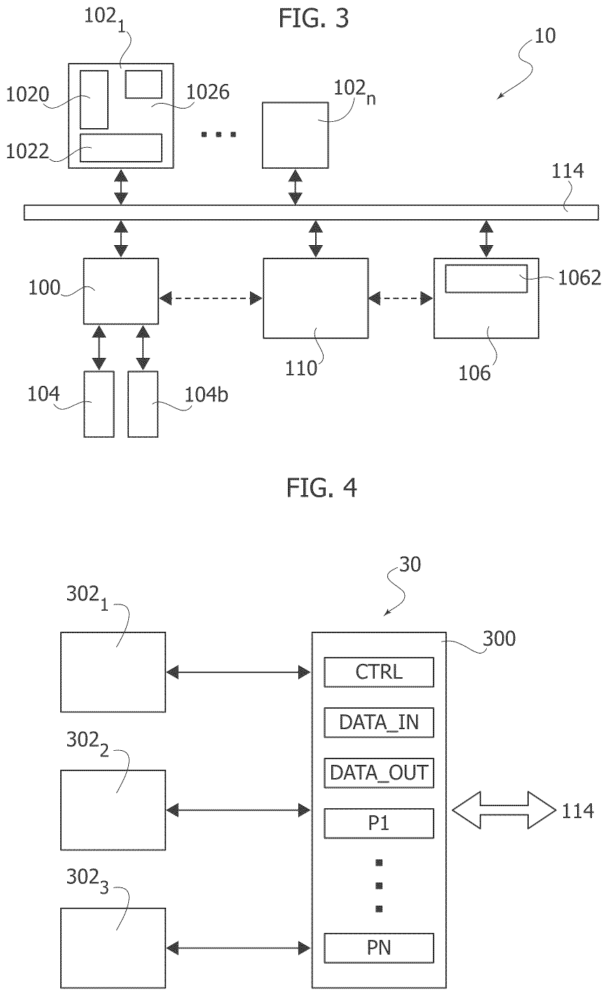

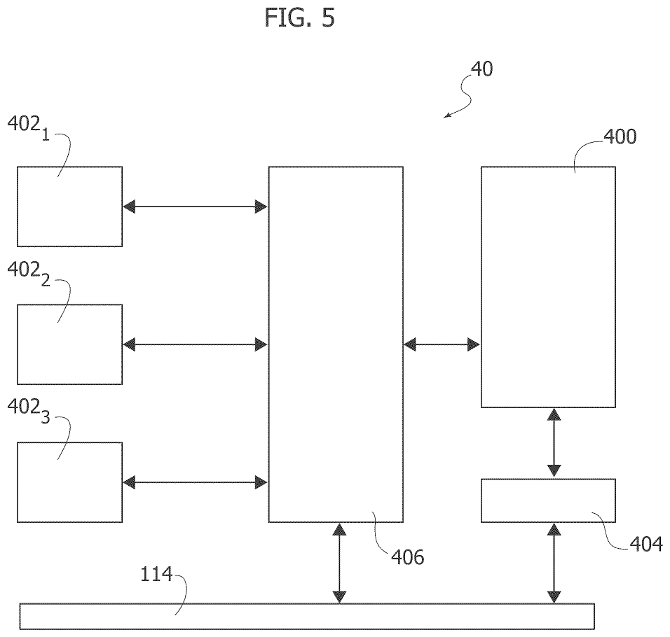

In the following FIGS. 5 to 18 parts, elements or components which have already been described with reference to FIGS. 1 to 4 are denoted by the same references previously used in such Figure; the description of such previously described elements will not be repeated in the following in order not to overburden the present detailed description.

As mentioned before, various embodiments of the present disclosure relate to a co-processor. FIG. 5 shows an embodiment co-processor 40 according to the present disclosure. In this respect, the term “co-processor” includes any kind of processing circuit operating in collaboration with a further processing core, e.g. comprising at least one of a microprocessor, a programmable logic circuit and a hardware finite state machine (FSM). For a general description of processing systems, such as microcontrollers, comprising such a co-processor, reference can be made to the previous description of FIGS. 1 to 3.

Specifically, in the embodiments considered, the co-processor 40 comprises at least one hardware processing circuit 402. For example, in FIG. 5 are shown three processing circuits 4021, 4022 and 4023. The co-processor comprises also a finite state machine 400. In various embodiments, the FSM 400 is a hardware FSM, i.e., implemented with a hardware sequential logic circuit.

In various embodiments, the co-processor 40 comprises a first memory 404 and a second memory 406. In various embodiments, the first memory 404 is used to store control data CTRL. Conversely, the second memory 406 is used to store configuration data for the processing operation to the executed by the co-processor 40.

For example, in various embodiments, the first memory 404 is programmable to start a processing operation of the co-processor 40. For example, in various embodiments, the first memory 404 is implemented with one or more registers. For example, in various embodiments the registers 404 are connected to a communication system 114 of a processing system comprising the co-processor 40, e.g., via a peripheral bridge, whereby the memory 404 is programmable by sending write requests to the communication system 114. For example, such write requests may be generated by a processing core 102, a general-purpose DMA controller 110 or an integrated DMA controller of a peripheral/resource 106. For example, in this way the processing operation of the co-processor 40 may be started in response to a request from a processing core 102, the completion of an analog-to-digital conversion or the reception of data via a communication interface.

Conversely, the second memory 406 is used to store configuration data for the processing operation to be executed by the co-processor 40. Based on the specific operation to be executed by the co-processor 40, the configuration data may be fixed or (at least in part) programmable. For example, in case the configuration data are fixed, the second memory 406 may be implemented with a Read-Only Memory (ROM). Conversely, in case the configuration data are programmable, the memory 406 may be implemented with programmable memory, wherein the memory 406 may be a volatile memory, such as a Random Access Memory (RAM), or a non-volatile memory, such as a flash memory. For example, in various embodiments, in order to provide a fully configurable co-processor 40, the second memory 406 is implemented with a RAM connected to the communication system 114.

The programming of the configuration data stored to of the second memory 406 may be performed in any suitable manner. For example, the configuration data may be programmed via software instructions executed by a microprocessor 102 or may be transferred via a DMA controller from another memory, e.g., the memory 104 or 104b, to the second memory 406. For example, in various embodiments, the configuration data may be transferred automatically from the non-volatile memory 104 during the start-up of the processing system.

Generally, while not shown in FIG. 5, the memory 406 also includes a respective memory controller in order to read data, and optionally write data to the memory 406.

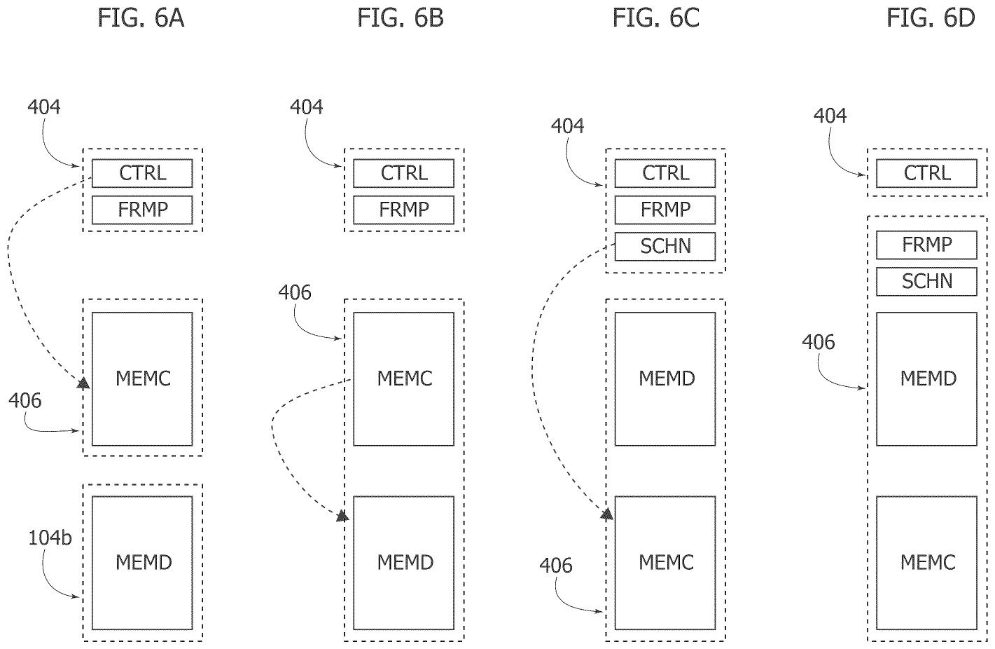

FIGS. 6A to 6D show possible embodiments of the data stored to the first memory 404 and the second memory 406.

Specifically, as mentioned before, the first memory 404, e.g., implemented with register interface connected to the communication system 114, is used to store control data CTRL used to start a processing operation of the co-processor 40. For example, the control data CTRL may comprise one or more start-flags, wherein the co-processor 40 is configured to start a processing operation in response to determining that a start-flag is asserted. In various embodiments, the co-processor 40 may be configured to receive directly the respective control signals CTRL.

Conversely, the second memory 406 is used to store configuration data. Specifically, the configuration data are stored to a memory area MEMC of the second memory 406.

In various embodiments, the memory area MEMC is stored to a fixed memory area (see e.g. FIGS. 6A and 6B). In other embodiments, the address range of the memory area MEMC (or in general of the respective configuration data) within the memory 406 may be configurable, e.g., programmable. For example, FIGS. 6C and 6D show embodiments wherein configuration data are stored to a memory area MEMC, and the start-address of the memory area MEMC is stored as data SCHN. In general, the start-address data SCHN may be stored to a predetermined location of the first memory 404 (FIG. 6C) or the second memory 406 (FIG. 6D). Accordingly, while in the following reference will be made to the start-address data SCHN, these data may indeed be hard-wired or programmable.

In various embodiments, the processing operation executed by the co-processor 40 processes given input data and generates respective output data. These input and output data may be stored to a further memory area MEMD.

In various embodiments, as shown in FIG. 6A, the memory area MEMD is within a memory being external with respect to the co-processor 40, such as a volatile memory 104b of the processing system. For example, in this case, the co-processor 40 may access the memory 104b via a DMA controller. Conversely, as shown in FIG. 6B, in various embodiments, the memory area MEMD is within the second memory 406. Specifically, in this case, the memory 406 should be a programmable memory, such as a RAM. In various embodiments, the embodiments may also be combined, i.e., the memory area MEMD may be within the memory 104, memory 104b and/or memory 406.

Also the location of the memory area MEMD within the respective memory may be fixed or programmable. However, the inventors have observed that it is usually not required to explicitly specify the address range of the memory area MEMD, but it is preferable to specify the address of the input data and the address of the output data within the configuration data stored to the memory area MEMC (see also FIG. 6B). Accordingly, in various embodiments, the configuration data stored to the memory area MEMC may comprise an input-data address indicating the (start) address of the input data and an output-data address indicating the (start) address of the output data. In various embodiments, the co-processor 40 is configured, such that each of these addresses may point to the second memory 406 and/or a memory external with respect to the co-processor 40, such as the memory 104b. Moreover, as will be described in greater detail in the following, in various embodiments, the co-processor 40 may also be configured to transfer data from an external memory, e.g., the memory 104b, to the second memory 406, and vice versa from the second memory 406 to an external memory, e.g., the memory 104b. Those of skill in the art will appreciate that an access to a local memory 406 is usually faster than the access to a memory connected to the communication system 114, such as the memory 104b.

In various embodiments, the co-processor 40 manages also a frame-pointer FRMP arranged to indicate a memory address within the memory area MEMC. In general, the frame-pointer FRMP may be stored to a predetermined location of the first memory 404 (see e.g. FIGS. 6A to 6C) or the second memory 406 (see FIG. 6D).

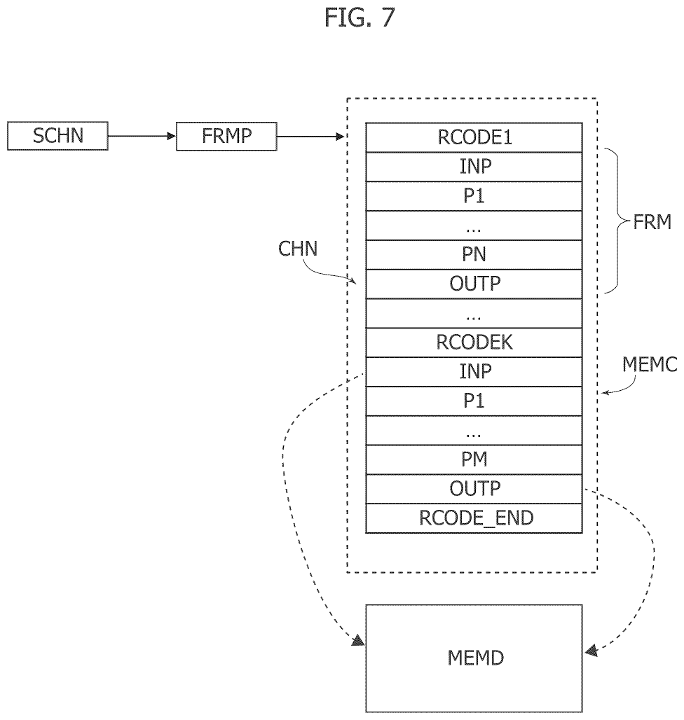

FIG. 7 shows an embodiment of the operation of the co-processor 40. Specifically, as mentioned before, in various embodiments, the memory area MEMC comprises configuration data for the processing operation or operations to be executed by the co-processor 40. Specifically, in various embodiments, these configuration data comprise for each processing operation to be executed by a processing circuit 402 a code RCODE indicating the identification of the processing circuit 402, which should execute the respective processing operation, and the respective configuration data, which are organized as a frame of configuration data FRM. For example, for this purpose, each processing circuit 402 may have associated a respective univocal identification/code, wherein one of these codes is stored to the respective field RCODE.

In general, as will be described in greater detail in the following, a frame of configuration data FRM may have any structure and it is sufficient that the frame of configuration data FRM is able to provide the needed configuration data to the selected processing circuit 402. For example, in various embodiments, a frame of configuration data FRM may comprise a first pointer INP indicating the (start) address within the memory area MEMD where the input data to be processer are stored and a second pointer OUTP indicating the (start) address within the memory area MEMD where the processed output data should be stored. Moreover, in various embodiments, the frame of configuration data FRM comprises one or more configuration parameters P for the processing operation to be executed by the selected processing circuit 402. In general, the first pointer INP, the second pointer OUTP and the parameters P may have any (predetermined) order within a frame of configuration data FRM.

Specifically, as shown in FIG. 7, the number of parameters P may be different for the various processing circuits 402. For example, in the embodiment considered, a first processing operation should be executed by a first processing circuit 402, identified via a first code RCODE1, wherein the respective processing operation comprises a frame of configuration data FRM with N configuration parameters, e.g., P1 to PN. Conversely, a k-th processing operation should be executed by a k-th processing circuit 402, identified via a code RCODEK, wherein the respective processing operation comprises a frame of configuration data FRM with M configuration parameters, e.g., P1 to PM. In general, the number of parameters may also vary for the same processing circuit 402 based on the processing operation to be executed. Moreover, one or more processing circuits 402 may also not require any parameters P.

Specifically, in various embodiments, the various codes RCODE and frames of configuration data FRM are stored in sequence to the memory area MEMC, wherein each code RCODE associated with a respective processing operation to be executed by a given processing circuit 402 is followed by the respective frame of configuration data FRM. The complete sequence of codes RCODE and frames of configuration data FRM will also be referred to as processing chain CHN in the following, i.e., the memory area MEMC is configured to store data identifying a processing chain CHN specifying one or more processing operations, e.g., K processing operations, wherein the data comprise for each processing operation a code RCODE and the respective frame of configuration data FRM.

In various embodiments, the processing chain CHN has also stored data indicating how many processing operations should be executed. For example, for this purpose the first memory slot of the memory area MEMC may comprise a field indicating the number K of processing operations to be executed. Additionally or alternatively, a last memory slot of the processing chain CHN may indicate the end of the processing operations, as shown in FIG. 7 via an end-code RCODE_END. For example, the end-code RCODE_END may follow immediately the last frame of configuration data FRM.

As will be described in greater detail in the following, in various embodiments the co-processor 40 uses the frame-pointer FRMP to indicate a current memory location to be read. Accordingly, in order to sequentially read the data stored to the memory area MEMC, the co-processor 40 may set the value of the frame-pointer FRMP to the start-address SCHN (indicating the start-address of the processing chain CHN), and then sequentially read the various data stored to the processing chain CHN, e.g., until the end-code RCODE_END is detected.

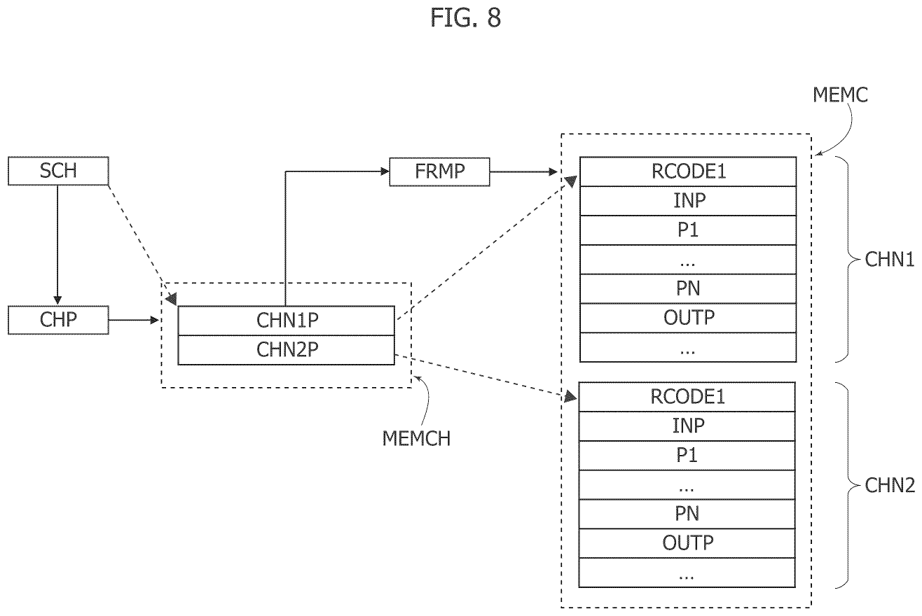

FIG. 8 shows a further embodiment. Specifically, in the embodiment considered, the memory area MEMC may comprise a plurality of processing chains CHN, e.g., a first processing chain CHN1 and a second processing chain CHN2. In this case, the co-processor 40 may be configured to selectively execute one of the processing chains CHN as a function of the control data CTRL. For example, a first flag in the register CTRL may indicate that the first processing chain CHN1 should be executed and a second flag in the register CTRL may indicate that the second processing chain CHN2 should be executed. For example, in various embodiments, the control register CTRL may comprise a number of start-flags, each associated with a respective processing chain CHN. For example, the number of start-flags may be greater than 2, e.g., selected in a range between 2 and 64, e.g., between 4 and 32, e.g., 8 or 16 start-flags.

Accordingly, in various embodiments, the co-processor 40 may analyze the content of the memory area MEMC in order to determine the start-addresses of one or more processing chains CHN stored to the memory area MEMC, e.g., a start-address pointer CHN1P for the first processing chain CHN1 and a start-address pointer CH2P for the second processing chain CHN2, e.g., by monitoring the position of the end-code RCODE_END. Accordingly, in response to determining that a start-flag is asserted, the co-processor 40 may determine which processing chain CHN should be executed, determine the respective start-address, e.g., CHN1P or CHN2P, and sequentially read the respective processing chain CHN via the frame-pointer FRMP, starting from the respective start-address.

Conversely, FIG. 8 shows an alternative embodiment, wherein the co-processor 40 comprises a further memory area MEMCH configured to store processing chains configuration data. Specifically, in the embodiment considered, the memory area MEMCH stores for each processing chain the respective start-address, e.g., the pointers CHN1P and CHN2P for the processing chains CHN1 and CHN2.

In various embodiments, the memory area MEMCH is stored to the first memory 404 or preferably the second memory 406. In various embodiments, the memory area MEMC is stored to a fixed memory area within the memory 406. In other embodiments, the address range of the memory area MEMCH within the memory 406 may be configurable, e.g., programmable. For example, FIG. 8 shows an embodiment wherein processing chains configuration data are stored to a memory area MEMCH, and the start-address of the memory area MEMCH is stored as data SCH. In general, similar to the start-address data SCHN, the start-address data SCH may be stored to a predetermined location of the first memory 404 or the second memory 406. Accordingly, while in the following reference will be made to the start-address data SCH, these data may indeed be hard-wired or programmable.

Accordingly, in response to determining that a given processing chain CHN should be executed, the co-processor 40 may access the memory area MEMCH in order to determine that start-address of the respective processing chain CN. For example, in the embodiment considered, each start-flag is associated univocally with a respective processing chain CHN, e.g., the first start-flag is associated with the first processing chain CHN1, the second start-flag is associated with the second processing chain CHN2, etc. Accordingly, the co-processor 40 may access, e.g., via a chain-handler pointer CHP, a memory address determined as a function of the start-address SCH and the asserted start-flag. For example, in order to determine the value of the start-address pointer CHN1P of the first processing chain CHN1 associated with the first start-flag, the co-processor 40 may access the memory location at the address SCH. Conversely, in order to determine the value of the start-address pointer CHN2P of the second processing chain CHN2 associated with the second start-flag, the co-processor 40 may access the memory location at the address SCH+1, etc.

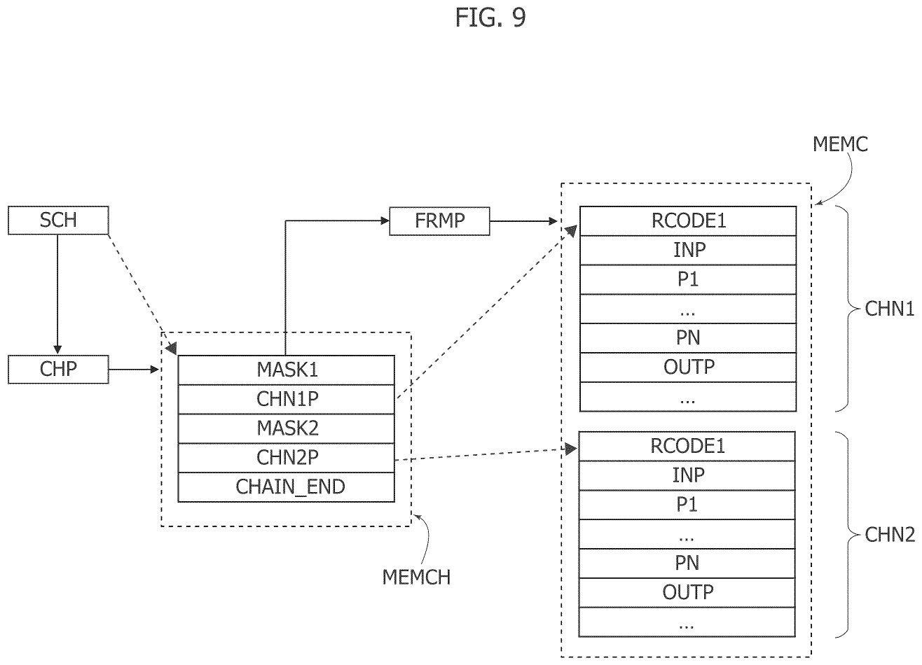

FIG. 9 shows a further embodiment, wherein the mapping between the start-flags and the processing chains CHN is configurable. Specifically, in this case, the memory area MEMCH comprises for each processing chain CHN respective chain-handler configuration data, which comprise a mapping rule and the respective start-address of the processing chain. For example, in the embodiment considered, the memory area MEMCH has stored a first mapping rule MASK1 and the start-address CHN1P of the chain CHN1, and a second mapping rule MASK2 and the start-address CHN2P of the chain CHN2. Accordingly, in this case, the co-processor 40 may sequentially read the memory area MEMCH, e.g., via the chain-handler pointer CHP and starting from the address SCH, until a mapping rule applies to the currently asserted start-flag (or flags). For example, in various embodiments, each mapping rule MASK corresponds to a mask. For example, in case the mask MASK has asserted the bit at the bit position of the currently asserted start-flag, the co-processor 40 may determine that the mapping rule applies. Accordingly, once having determined that a mapping rule applies, the co-processor 40 may read the next memory location of the memory area MEMCH in order to determine the start-address of the processing chain CHN to be executed. Next, the co-processor 40 may sequentially read the data of the respective processing chain CHN via the frame pointer FRMP, starting from the respective start-address of the processing chain CHN to be executed.

In various embodiments, the number of mapping rules stored to the memory area MEMCH may be fixed. Alternatively, the memory area MEMCH may comprise data indicating the number of mapping rules stored to the memory area MEMCH, e.g., via an end-code CHAIN_END indicating the end of the memory area MEMCH.

In various embodiments, instead of using a sperate chain-handler pointer CHP, the co-processor 40 may also use a common pointer for reading the memory areas MEMC and MEMCH. However, the use of a separate chain-handler pointer CHP is preferable, because in this way the mapping rules MASK may also indicate that a plurality of chains should be executed in sequence. Accordingly, by using a separate chain-handler pointer CHP, the co-processor 40 may continue with the analysis of the memory area MEMCH once a processing chain CHN has been executed/processed.

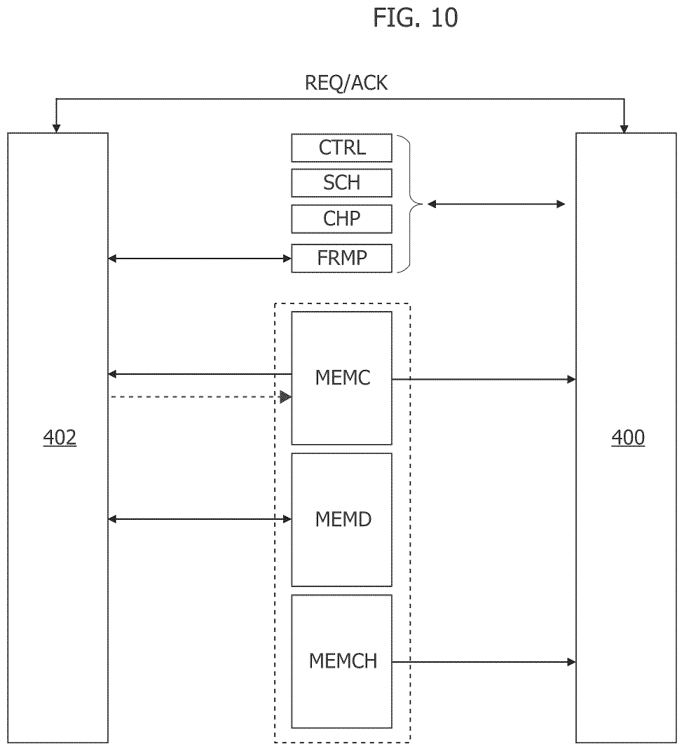

FIG. 10 shows an embodiment of the separation of the operations executed by the co-processor 40 between the FSM 400 and the processing circuit(s) 402.

Specifically, as described in the foregoing, the co-processor 40 uses the control data CTRL in order to indicate whether the processing chain CHN should be started (FIG. 7) or whether a given processing chain CHN of a plurality of processing chains should be started (FIGS. 8 and 9). Specifically, in various embodiments, the FSM 400 monitors for this purpose the control signals CTRL.

For example, with respect to the embodiment shown in FIG. 7, in response to determining that the processing chain CHN should be started, the FSM 400 determines the start-address SCHN of the processing chain CHN and reads via the frame-pointer FRMP the content of the respective (first) memory location of the memory area MEMC, which should comprise the identification of a first processing circuit 402, i.e., the data RCODE1. Next the FSM 400 determines the processing circuit 402 associated with the code RCODE1 and starts the respective processing circuit 402, e.g., via a request signal REQ.

Conversely with respect to the embodiment shown in FIGS. 8 and 9, in response to determining that a processing operation should be started, the FSM 400 determines which processing chain CHN should be started based on the control data CTRL, and optionally the mapping rules MASK (see FIG. 9). Moreover, the FSM 400 determines the start-address of the selected processing chain CHN, e.g., by reading the respective start-address from the memory area MEMCH. For example, the FSM 400 may determine the start-address SCH of the memory area MEMCH and then read the content of the memory area MEMCH via the chain-handler pointer CHP in order to determine the start-address associated with the processing chain CHN to be executed. Next, the FSM 400 reads via the frame-pointer FRMP the content of the respective memory location of the memory area MEMC, which should comprise the identification of a first processing circuit 402, i.e., the data RCODE1. Next the FSM determines the processing circuit 402 associated with the code RCODE1 and starts the respective processing circuit 402, e.g., via the request signal REQ.

Accordingly, irrespective of whether the memory area MEMC comprises a single processing chain CHN or a plurality of processing chains CHIN, the FSM 400 determines a first processing circuit 402 to be started as a function of the respective first code RCODE1 of the processing chain CHN or the selected processing chain CHN.

In this respect, in the embodiments considered, the first code RCODE1 is followed by the respective frame of configuration data FRM1 to be used by the selected processing circuit 402. For this reason, in various embodiments, the selected processing circuit 402 uses the frame-pointer FRMP in order to read the frame of configuration data FRM to be used for the processing operation. For example, for this purpose the FSM 400 or the selected processing circuit 402 may increase the frame-pointer FRMP in order to indicate the first memory location of the respective frame of configuration data FRM.

Accordingly, based on the frame of configuration data FRM, the selected processing circuit 402 processes the input data stored to the memory area MEMD, as indicated, e.g., via the respective pointer INP, and stores the processed data to the memory area MEMD, as indicated, e.g., via the respective pointer OUTP, wherein the processing operation may use the respective parameters P. Optionally, as will be described in greater detail in the following, the selected processing circuit 402 may also update (at least in part) the frame of configuration data FRM, e.g., the processing circuit 402 may update one or more of the parameters P.

Specifically, in various embodiments, the selected processing circuit 402 updates the frame-pointer FRMP in order to indicate the last position of the frame of configuration data FRM or directly the next memory address indicating a code RCODE. Moreover, the selected processing circuit 402 signals the completion of the processing operation, e.g., via an acknowledge signal ACK.

Accordingly, in response to determining that the selected processing circuit 402 signals the completion of the processing operation, the FSM 400 may read the next code RCODE, and repeat the above operations for the next code. In various embodiments, in case the selected processing circuit 402 updates the frame-pointer FRMP to indicate the last position of the frame of configuration data FRM, the FSM 400 may also first increase the frame-pointer FRM in order to read the next code RCODE.

In various embodiments, the above operations are thus repeated for all processing operations specified in the chain of processing operations CHN, e.g., until the number K of processing operations are executed or the code RCODE corresponds to the end code RCODE_END.

Accordingly, in various embodiments, the FSM 400 just determines, which processing circuit 402 should be started, while the selected processing circuit 402 autonomously reads the frame of configuration data FRM. Accordingly, the FSM 400 does not need to have any knowledge concerning the length and content of the frame of configuration data FRM. Conversely, the selected processing circuit 402 reads the frame of configuration data FRM and increased the frame-pointer FRM, whereby the FSM 400 may determine the next processing circuit 402 to the started (or the end of the processing chain CHN).

Accordingly, in the embodiments disclosed with respect to FIGS. 5 to 10, the memory 406 is configured to store one or more processing chains CHN, also identified as chain frames. Each chain frame CHN is associated with a given sequence of processing operations, wherein each processing operation is specified via a code RCODE indicating which processing circuit 402 should execute the respective processing operation, and a frame of configuration data FRM for the respective processing operation, e.g., comprising data identifying a memory address INP having stored the input data to be processed, data identifying a memory address OUTP for storing the processed output data, and optional parameters P for the processing operation. Accordingly, in various embodiments, each frame of configuration data FRM may comprise a given number of configuration data, which depend on the processing circuit 402 to be started and/or the processing operation to the executed by the processing circuit 402.

Specifically, in order to manage the executing of a given processing chain CHM, the FSM uses the frame pointer FRMP. Specifically, also when using the chain-handler memory MEMCH, the FSM 400 determines the start-address of a chain frame CHN to be processed. Next, the FSM sets the frame-pointer FRMP to the start-address of the chain frame CHN, and reads the content of the respective memory slot of the chain frame CHN, which should correspond to a code RCODE, i.e., the identification of a processing circuit 402. Next, the FSM 400 enabled the respective processing circuit 402, e.g., via the respective signal REQ.

Once enabled, the processing circuit 402 knows how many parameters are associated with the processing circuit 402 and optionally the selected processing operation, and may sequentially read the respective data of the frame of configuration data FRM by using the frame-pointer FRM. In this respect, preferably, the FSM 400 may already increase the frame-pointer by one in order to indicate directly the first memory location containing the frame of configuration data FRM. Similarly, while reading sequentially the given number of processing parameters from the memory, the selected processing circuit 402 may increase the frame-pointer FRMP, whereby once the selected processing circuit 402 has completed the processing operation, e.g., signaled via the respective signal ACK, the FSM 400 may directly read the next memory location of the chain frame CHN, in order to determine whether the slot comprises a code RCODE associated with a next processing operation, or an end-code RCODE_END.

Thus, essentially, the FSM 400 enables sequentially one or more processing circuits 402 based on the code RCODE and each enabled processing circuit 402 is configured to read autonomously the respective frame of configuration data FRM from the memory area MEMC, preferably while increasing the frame pointer FRMP. Accordingly, in this way, the same processing circuit 402 may be started several times with a different frame of configuration data FRM.

Thus, in case only a single processing chain/chain frame CHN is supported, just the frame-pointer FRMP would be sufficient. Conversely, in order to support different chain frames CHN, the frame-pointer FRMP should be set to the start-address of the selected chain frame CHN. For this purpose, in various embodiments, the memory area MEMC may comprise a chain-handler memory MEMCH having stored for each chain frame the respective start-address. Additionally, the chain-handler memory MEMCH may also have stored mapping rules MASK, e.g., in the form of valid flags indicating whether a given chain frame CHN should be processed for a given start-flag of the control data CTRL. For example, the control data CTRL may comprise various start-flags, and the chain-handler memory MEMCH may have stored a mask MASK indicating whether the respective chain frame CHN should be executed for a given asserted start-flag.

Accordingly, in various embodiments, the FSM 400 reads in sequence the content of the chain-handler memory MEMCH and determines whether a given chain frame CHN should be processed. For example, for this purpose the FSM 400 uses a further chain-handler pointer CHP. Accordingly, by sequentially reading the content of the chain-handler memory MEMCH, the FSM 400 may determine whether a given chain frame should be processed, and in case the chain frame CHN should be processed, the FSM 400 may set the frame-pointer FRMP to the respective start-address indicated in the chain-handler memory MEMCH. As mentioned before, instead of using a separate chain-handler pointer CHP, a single pointer may be used for both the frame-pointer FRMP and the chain-handler pointer CHP.

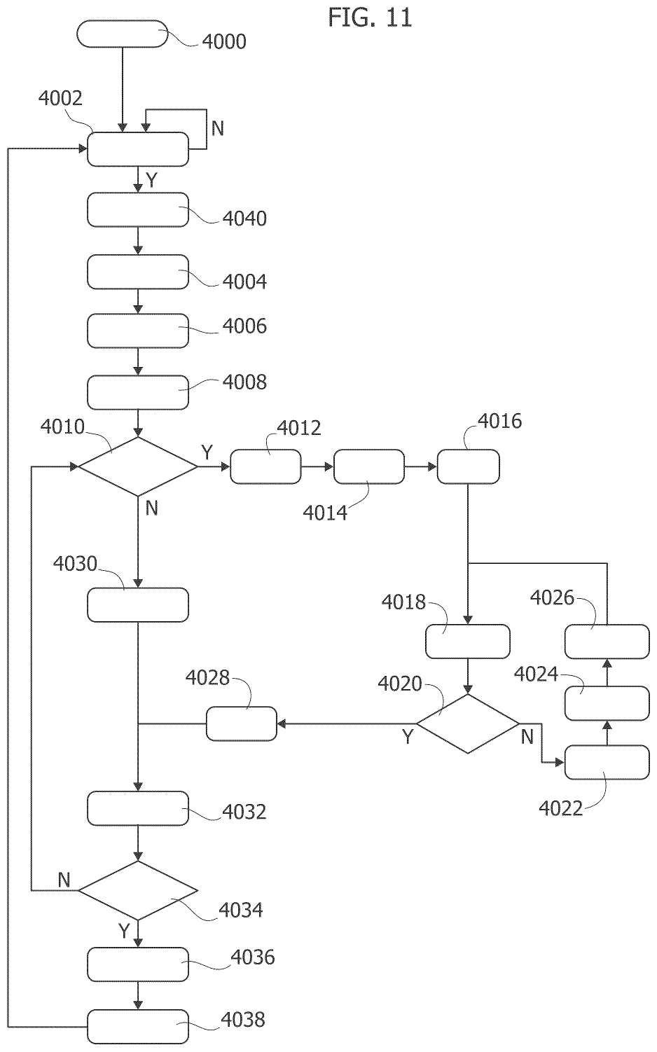

FIG. 11 shows a flow chart describing in greater detail an embodiment of the operation of the FSM 400.

Specifically, after a start step 4000, the FSM 400 proceeds to a wait step/state 4002. For example, the start step 4000 may correspond to the instant when the FSM is enabled, e.g., by receiving a supply voltage and a clock signal. Optionally, the FSM 400 may be enabled as a function of an enabled flag in the control data CTRL.

In various embodiments, the FSM 400 remains in the wait state 4002 until the control data CTRL indicate that a processing operation should be started, e.g., because a start-flag of the control data CTRL is asserted. As described in the foregoing, the control data CTRL may comprise a single start-flag associated with a single processing chain CHN, or a plurality of start-flags which may be associated with predetermined processing chains CHN or mapped to one or more processing chains CHN, e.g., via the mapping data MASK. In various embodiments, a start-flag may be asserted by means of a respective write request sent via the communication channel 114 or via an interrupt line. For example, the write requests may be generated via the processing core 102. Conversely, the interrupt line may be connected to a resource/peripheral 106, such as a sensor, an analog-to-digital converter or a communication interface. For example, in various embodiments, the control register CTRL comprises a first subset of start-flags programmable via a processing core 102, such as a microprocessor, and a second subset of start-flags configured to be connected to the interrupt lines of a resource/peripheral 106.

As mentioned before, once a processing operation should be started, the FSM 400 sets the frame-pointer FRMP to the start-address of the processing chain/chain frame CHN to be executed. For example, in the embodiment considered, this operation is implemented at the step 4016. For example, when supporting just a single processing chain CHN, the FSM 400 may directly proceed to the step 4016 and set the frame-pointer FRMP to the processing chain start-address SCHN.

Conversely, FIG. 11 shows an embodiment, wherein a chain-handler memory area MEMCH and mapping rules MASK are used (see also the description of FIG. 9).

Specifically, in the embodiment considered, the FSM 400 obtains at a step 4004 the channel-handler start-address SCH, sets at a step 4006 the chain-handler pointer CHP to the start-address SCH and reads at a step 4008 the content of the memory location indicated by the chain-handler pointer CHP.

Specifically, in the embodiment considered, this memory location should contain a mapping rule MASK, such as a mask. Accordingly, at a step 4010, the FSM 400 determines whether the corresponding processing chain CHN should be processed by comparing the content of the control data CTRL with the mapping rule MASK. For example, the FSM 400 may determine which start-flag of the control data CTRL is asserted and whether the mapping rule MASK has asserted the corresponding flag.

Accordingly, in the embodiment considered, when the mapping rule MASK indicates that the respective processing chain CHN should be processed (output “Y” of the verification step 4010), the FSM 400 proceeds to a step 4012, where the FSM 400 increases the value of the chain-handler pointer CHP by one, thereby indicating the memory location of the chain-handler memory area MEMCH, which should comprise the start-address of the respective processing chain/chain frame CHN. Accordingly, in the embodiment considered, the FSM 400 may read at a step 4014 the content of the memory location indicated by the chain-handler pointer CHP and set at the step 4016 the frame handler pointer FRMP to the value read.

Conversely, in the embodiment considered, when the mapping rule MASK indicates that the respective processing chain CHN should not be processed (output “N” of the verification step 4010), the FSM 400 proceeds to a step 4030, where the FSM 400 proceeds to the next mapping rule MASK. For example, in various embodiments, the FSM 400 increases the chain-handler pointer CHP by two, thereby indicating the memory location of the next mapping rule MASK in the chain-handler memory area MEMCH. Next, the FSM 400 reads at a step 4032 the content of the memory location indicated by the chain-handler pointer CHP.

Specifically, in various embodiments, the FSM 400 determines at a step 4034, whether the data read at the step 4032 indicate a new mapping rule MASK or the end of the processing chain CHAIN_END. In various embodiments, the steps 4030 to 4034 may also be implemented differently, because it is sufficient that the FSM 400 is able to analyze in sequence the various mapping rules stored to the chain-handler memory area MEMCH.

Accordingly, in case the FSM 400 determines a new mapping rule (output “N” of the verification step 4034), the FSM returns to the step 4010 in order to analyze the next mapping rule MASK. Conversely, in case the FSM 400 reaches the end of the chain-handler memory area MEMCH (output “Y” of the verification step 4034), the FSM proceeds to a step 4036. For example, in various embodiments, the FSM 400 clears at the step 4036 the start-flags of the control data CTRL. Additionally or alternatively, in various embodiments, the FSM 400 also generates a control signal indicating the end of the processing operation. For example, this signal may be stored to the control data CTRL and/or used to generate an interrupt, e.g., an interrupt of the processing core 102.

Once having complete the processing operations, the FSM 400 returns to the wait state 4002.

Accordingly, when supporting a single processing chain CHN, the FSM 400 may directly set at the step 4016 the frame handler pointer FRMP to the start-address SCHN of the processing chain CHN. Conversely, when supporting a plurality of processing chains CHN, the FSM 400 may analyze the data stored to the chain-handler memory area MEMCH, and optionally the respective mapping rules MASK, in order to select a processing chain CHN to be processed and determine the respective start-address of the selected processing chain CHN. Next, the FSM 400 sets at the step 4016 the frame handler pointer FRMP to the start-address of the selected processing chain CHN.

Once having set the frame-pointer FRMP at the step 4016, the FSM 400 reads at a step 4018 the content of the memory location indicated by the frame-pointer FRMP. Next, at a step 4020, the FSM 400 determines whether the data read indicate a code RCODE of a processing circuit 402 to be started or an end-code RCODE_END.

In the embodiment considered, in case the code read at the step 4018 corresponds to the end-code RCODE_END (output “Y” of the verification step 4020), the FSM 400 increases at a step 4028 the chain-handler pointer CHP by one and proceeds to the step 4032, where the FSM 400 reads the entry of the chain-handler memory area MEMCH. Specifically, while the step 4030 increases the chain handler pointer by two, the steps 4012 and 4028 increase the chain-handler pointer CHP each time by one. For example, this permits to execute in sequence a plurality of processing chains CHN in response to the same start-flag. Conversely, in case the co-processor 40 just supports a single processing chain CHN or should just execute a single processing chain CHN, the FSM 400 may directly return to the wait step 4002.

Conversely, in case the code read at the step 4018 does not correspond to the end-code RCODE_END (output “N” of the verification step 4020), the FSM 400 starts at a step 4022 the processing circuit 402 indicated by the code RCODE read at the step 4018. For example, as mentioned before, the FSM 400 may be connected to each processing circuit 402 via a respective request signal REQ and the FSM 400 may assert the request signal REQ of the processing circuit 402 indicated by the code RCODE.

Next the FSM 400 proceeds to a wait state 4024, where the FSM 400 waits until the selected processing circuit 402 signals the completion of the processing operation. For example, as mentioned before, the FSM 400 may be connected to each processing circuit 402 via a respective acknowledge signal ACK and the FSM 400 may monitor the acknowledge signal ACK of the processing circuit 402 started at the step 4022. Alternatively, the processing circuit 402 may also use a common acknowledge signal, e.g., generated via a logic OR gate, wherein the FSM 400 monitors the common acknowledge signal ACK.

Accordingly, in various embodiments, once the selected processing circuit 402 signals the completion of the processing operation, e.g., once the FSM 400 detects that the acknowledge signal ACK of the selected processing circuit 402 is asserted or the common acknowledge signal ACK is asserted, the FSM proceeds to a step 4026. Specifically, in the embodiment considered, the FSM 400 increases at the step 4026 the frame-pointer FRM by one 4026, thereby indicating the next memory location in the chain frame CHN which should indicate a code RCODE. As mentioned before, this step 4026 is purely optional, because the selected processing circuit 402 may not only increase the frame-pointer FRMP in order to indicate the last memory location of the respective frame of configuration data FRM, but may already increase the frame-pointer FRMP to directly indicate the next memory location of a (next) code RCODE.

In various embodiments, the frame-pointer FRMP is directly exchanged between the FSM 400 and the processing circuit 402, e.g., by using a register being accessible by the FSM 400 and the processing circuit 402. Conversely, in case the frame-pointer FRMP is exchanged via the memory 406, e.g., a RAM, the FSM 400 may manage a local frame-pointer, e.g., stored to a register of the FSM 400, and the operations shown in FIG. 11 may comprise additional steps, in particular for transferring before the step 4022 the local frame-pointer to the memory location of the frame-pointer in the memory 406, and for transferring after the step 4022 the data at the memory location of the frame-pointer in the memory 406 to the local frame pointer. Similar operations, if required, may also be implemented in order to provide the chain-handler pointer CHP to the processing circuits 402.

In various embodiments, in order to reduce power consumption, before returning to the wait step 4002, the FSM 400 may place at a step 4038 one or more processing circuits 402 into a low-power mode. For example, the low-power mode may be activated by disabling the one or more (e.g., all) processing circuits 402, e.g., via an enable signal, switching-off the power supply of the one or more processing circuits 402 and/or reducing the clock frequency of the clock signal used to drive the one or more processing circuits 402. In this case, once a processing operation should be started (output “Y” of the verification step 4002), the FSM 400 may place at a step 4040 the one or more processing circuits 402 again in a normal-operation mode, i.e., by performing the complementary action(s) implemented at the step 4036. Alternatively, the FSM 400 may place at the step 4022 just the selected processing circuits 402 in the normal-operation mode. In this case, once having detected the end of the processing operation at the step 4024, the FSM 400 may place the selected processing circuits 402 in the low-power mode.

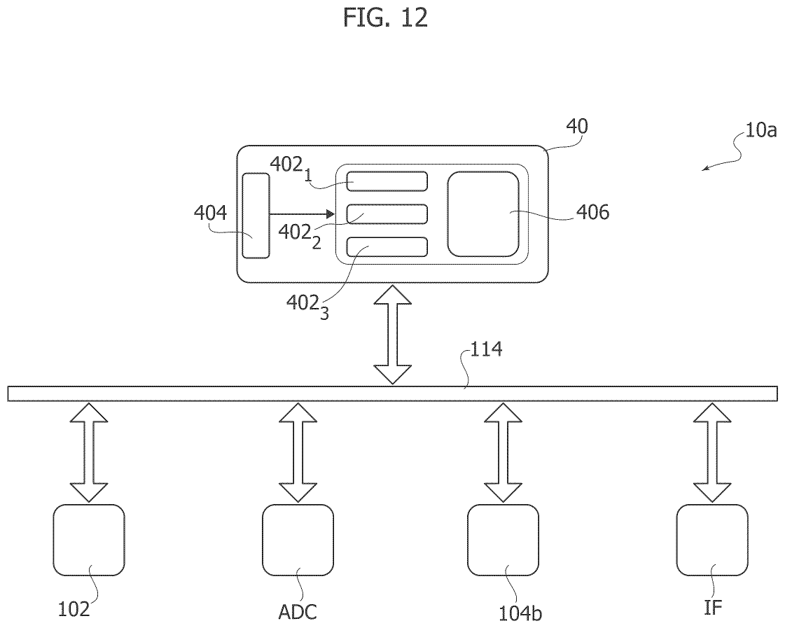

FIG. 12 shows an embodiment of a processing system 10a comprising the co-processor 40. Specifically, in the embodiment considered, the processing system 10a comprises a processing core 102, such as a microprocessor programmed via software instructions stored to a non-volatile memory 104 (not shown in FIG. 12), a co-processor 40 and a communication system 114 connecting the co-processor 40 with the processing core 102. In general, for a more detailed description of a processing system, reference is made to the description of FIGS. 1 to 3. For example, the processing system 10a may also comprise a volatile memory 104 and/or a DMA controller 110 and/or one or more resources/peripherals 106. For example, in FIG. 12 are shown a communication interface IF and an analog-to-digital converter ADC.

For example, in various embodiments, in order to configure one or more processing chains CHN, the memory area MEMC within the memory 406 may be programmed via the processing core 102, the DMA controller and/or the interface IF.

Conversely, the data to be processed may be stored in any memory of the processing system 10a, such as the shared memory 104b or the local memory 406 of the co-processor 40. Accordingly, once the control data CTRL indicate that a processing operation should executed, e.g., once a start-flag in the control data CTRL is asserted, the co-processor 40 starts a processing chain CHN stored to the memory area MEMC. For example, the control data CTRL may be programmed via any circuit connected to the communication system 114 or by providing dedicated signals, e.g., interrupt signals, to the co-processor 40. For example, in various embodiments, a start-flag of the control data CTRL may be asserted via a resource 106, such as the analog-to-digital converter ADC, which signals that given converted data have been stored to the shared memory 104b or directly the memory area MEMD in the local memory 406.

For example, in response to determining that the analog-to-digital converter ADC signals the completion of an analog-to-digital converter, e.g., via an interrupt signal, the co-processor 40 may start a processing chain CHN, which is configured to transfer the converted data from the shared memory 104b to a memory area MEMD in the local memory 406, process the respective data stored to the memory area MEMD and transfer the processed data from the memory area MEMD to the shared memory 104b or another memory, such as a First-In First-Out FIFO memory.

Alternatively, the processing core 102 (or another circuit) may program the control data CTRL to signal a request for executing a given processing chain CHN, e.g., by sending a write request to the communication system 114 comprising an address associated with the register CTRL of the co-processor.

In various embodiments, each processing circuit 402 may have respective hardware resources. However, in various embodiments, the processing circuits 402 may also share one or more hardware circuits, e.g., for accessing the memory 406 and/or for executing the processing operations. In various embodiments, each processing circuit 402 may be implemented in any suitable manner, e.g., comprising a hardware sequential logic circuit and/or a programmable circuit, such as a microprocessor programmed via software instructions and/or a programmable logic circuit, such as an FPGA. In this respect, a processing circuit 402 may also use a parallel and/or pipelined hardware architecture.

As mentioned before, the processing circuits 402 may implement various types of operations. For example, in various embodiments, the processing circuits 402 comprise at least one digital signal processing circuit. Such signal processing circuits are configured to implement mathematical transfer functions for generating processed output data as a function of input data. As mentioned before, in this respective the pointers INP and OUTP are used to indicate the (start) address of the input data and the output data, respectively. In various embodiments, a digital signal processing circuit 402 may implement a fixed mathematical function, or a parameterized mathematical function. For example, a fixed mathematical function may be a combinational logic operation, such as a logic NOT, AND or OR operation, basic mathematical functions, such as a sum and multiplication, a peak-detection, a sorting operation, etc. Conversely, a parameterized mathematical function may be used to implement a Fast Fourier Transform (FFT), a convolution operation, an artificial neural network, a cryptographic operation, etc.

In addition to these digital signal processing circuits, the co-processor may comprise further processing circuits 402.

For example, in various embodiments, one or more processing circuits 402 implement modifications to the sequential execution of the processing chain CHN, and may be used, e.g., to implement a delay, a down-sampling or conditioned operations.

Moreover, in various embodiments, one or more processing circuits 402 implement support functions. For example, a first support processing circuit may be configured transfer data between the memory 406 and a memory external with respect to the co-processor 40, such as a memory 104 or 104b. In various embodiments, these operations may be implemented via a DMA controller. Additionally or alternatively, a second support processing circuit may be configured to send read and/or write request to the communication system 114. Additionally or alternatively, a third support processing circuit may be configured to request the execution of a given operation via a further circuit external with respect to the co-processor 40. For example, the third support processing circuit may assert a request signal provided to the further circuit, such as an analog-to-digital converter, and wait until the further circuit asserts an acknowledge signal.

Accordingly, in various embodiments, the digital signal processing circuits and the chain-modifier circuits may be configured to only access the local resources of the co-processor, in particular the local memory 406, while these circuits are unable to communicate with the communication system 114 and the external memories, such as the memories 104 and 104b. Conversely, the communication with circuits external to the co-processor 40 may be managed by the support circuits, e.g., in order to read data from the memory 104b, send requests to the communication system 114 and/or directly interact with other circuits, e.g., peripherals 106.

In the following will now be described possible embodiments of processing circuit 402. In various embodiments, the co-processor 40 may comprise a sub-set or all of these circuits.

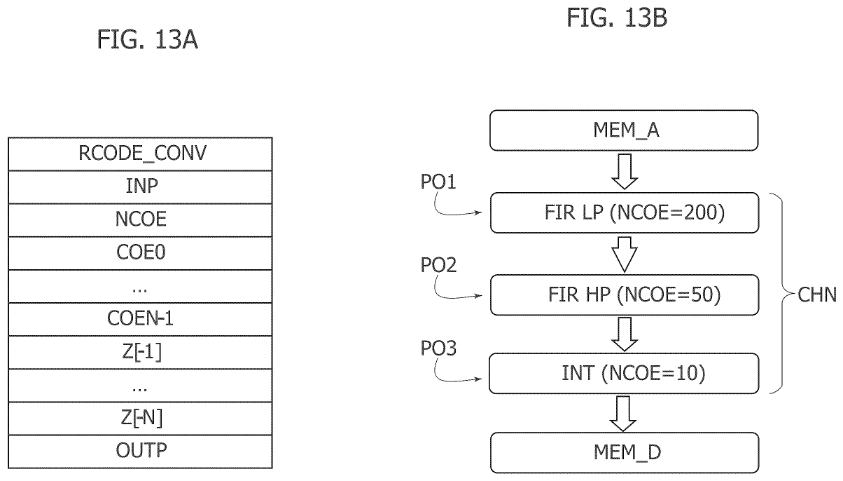

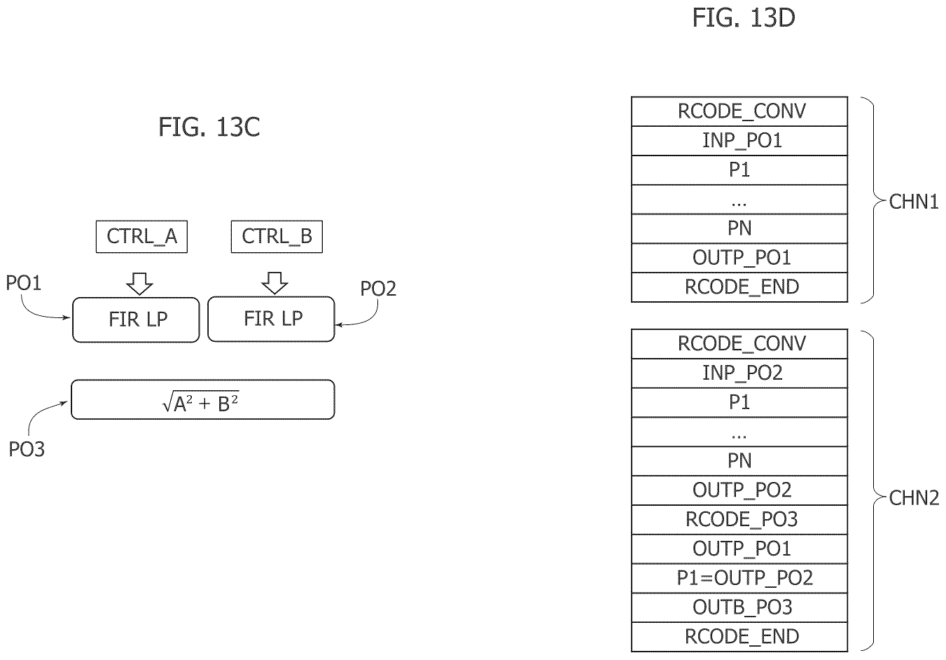

FIG. 13A shows an embodiment of a frame of configuration data FRM for a digital signal processing circuit 402, e.g., configured to implement a discrete convolution operation. For example, the respective processing circuit 402 may be identified via a code RCODE_CONV.

For example, as well known, a discrete convolution operation may be implemented with a Finite-Impulse Response (FIR) filter having a given order N, as described e.g. at the website of Wikipedia® relating to “Finite impulse response”. Specifically, in this case, an input is sequentially stored in a cascade of (N−1) buffer elements, and the output is computed via a weighted sum of the input and the buffered input values. Accordingly, the multiplication coefficients of the FIR and the state of the FIR stored to the buffer elements represent the current configuration of the FIR.

Accordingly, as shown in FIG. 13A, in various embodiments, the frame of configuration data FRM for the processing circuit 402 may include a given number N of coefficients COE, e.g., coefficients COE0 to COEN−1, and the state of the buffer elements Z, i.e., state values Z[−1] to Z[−N]. In various embodiments, also the order N of the filter may be configurable, i.e., the frame of configuration data FRM may comprise a field NCOE indicating the order N.

Specifically, in the embodiment considered, due to the fact that the state changes at each processing cycle, the processing circuit 402 is configured to update the frame of configuration FRM in order to update the state of the buffer elements Z, i.e., state values Z[−1] to Z[−N]. Accordingly, in this way, once a new processing operation is requested, the processing circuit 402 may use the last state of the buffer elements Z.

For example, FIG. 13B shows a possible processing chain CHN. Specifically, in the embodiment considered, given input data are stored to a memory address MEM_A. In the embodiment considered, the processing chain CHN is configured to implement:
a first processing operation PO1, wherein the convolution processing circuit 402 is configured via the frame of configuration data FRM to process the data stored to the memory MEMA with 200 coefficients, i.e., NCOE=200, wherein the respective coefficients COE are configured to implement a low-pass (LP) filter, and wherein the frame of configuration data FRM indicates that the input data should be read from the memory address MEM_A;
a second processing operation PO2, wherein the convolution processing circuit 402 is configured via the frame of configuration data FRM to process the data generated by the operation PO1 with 50 coefficients, i.e., NCOE=50, wherein the respective coefficients COE are configured to implement a high-pass (HP) filter; and
a third processing operation PO3, wherein the convolution processing circuit 402 is configured via the frame of configuration data FRM to process the data generated by the operation PO2 with 10 coefficients, i.e., NCOE=10, wherein the respective coefficients COE are configured to implement an integrator (INT), and wherein the frame of configuration data FRM indicates that the output data should be stored to a memory address MEM_D.

Accordingly, in the embodiments considered, the processing chain CHN would comprise three processing operations, which comprise each time the code RCODE_CONV associated with the convolution processing circuit 402 and a frame of configuration data FRM including the addresses INP and OUTP, and the respective configuration parameters P including the number NCOE, the respective coefficients COE and the respective state values Z. Specifically, in the embodiment considered, while the same processing circuit 402 is indicated, indeed the respective frames of configuration data FRM may have a different length based on the value NCOE and different coefficients COE. Moreover, eat each processing operation PO, the processing circuit 402 is configured to update the respective state parameters Z.

FIGS. 13C and 13D shows a second embodiment of operations implementable with the co-processor 40 of the present disclosure. Specifically, in the embodiment considered, a first start-flag CTRL_A is associated with a first processing chain CHN1 and a second start-flag CTRL_B is associated with a second processing chain CHN2.

Specifically, the first processing chain CHN1 is configured to implement a first processing operation PO1 corresponding to a low-pass filter for first input data. For this purpose, the first processing chain CHN1 comprises the code RCODE_CONV followed by a frame of configuration data FRM indicating that the first input data stored to an address INP_PO1 should be processed with respective parameters P1 to PN corresponding to the parameters described with respect to FIG. 13A, wherein the result of the processing operation should be stored to an address OUTP_PO1.

Conversely, the second processing chain CHN2 is configured to implement a second processing operation PO2 corresponding to a low-pass filter for second input data. For this purpose, the second processing chain CHN2 may comprise the code RCODE_CONV followed by a frame of configuration data FRM indicating that the second input data stored to an address INP_PO2 should be processed with respective parameters P1 to PN corresponding to the parameters described with respect to FIG. 13A, wherein the result of the processing operation should be stored to an address OUTP_PO2.

Moreover, the second processing chain CHN2 comprises a further processing operation PO3 configured to merge the results of the first processing operation PO1 and the second processing operation PO2, e.g., by implementing a root sum squared. For this purpose, the second processing chain CHN2 may comprise a code RCODE_PO3 associated with the respective processing circuit 402 followed by a frame of configuration data FRM indicating that the data stored to the address OUTP_PO1 and the data stored to the address OUTP_PO2 should be processed and the result should be stored to an address OUTP_PO3. For example, the second address OUTP_PO2 may be provided as a parameter P1 within the respective frame of configuration data FRM.

Accordingly, by using plural start-flags, indeed the result of different processing chains may be combined. In fact, while the first processing chain CHN1 generates first output data, the second processing chain CHN2 generates second output data and combines the first output data and the second output data.

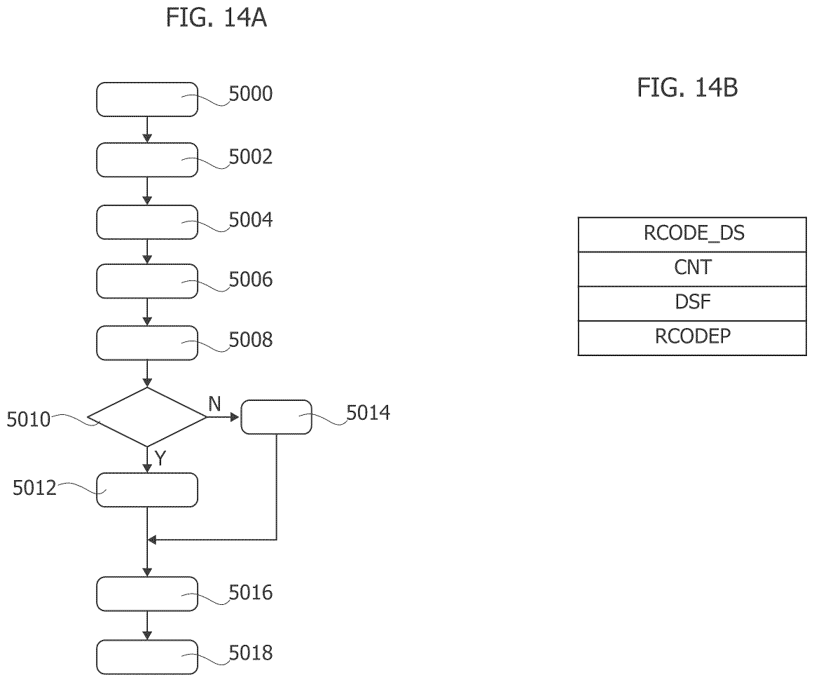

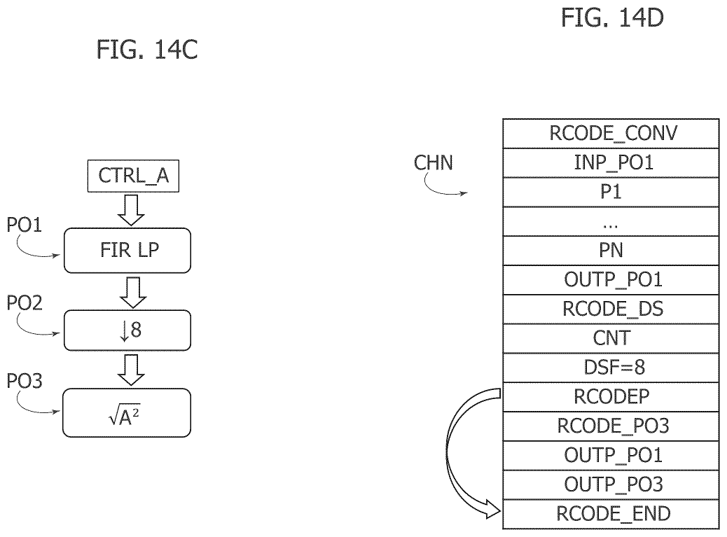

FIGS. 14A and 14B shows an embodiment of a chain-modifier processing circuit 402. Specifically, FIG. 14A shows an embodiment of the operation of a down-sampling circuit 402 identified via a code RCODE_DS, and FIG. 14B shows a respective frame of configuration data FRM.

Specifically, in the embodiment considered, in response to being enabled, e.g., in response to the respective request signal REQ, as schematically shown via a start step 5000, the processing circuit reads the frame of configuration data FRM. For example, in the embodiment shown in FIG. 14B, the frame of configuration data FRM comprises a count value CNT, a down-sampling factor DSF and the address RCODEP of a next code RCODE. Accordingly, in order to read these data, the processing circuit 402 may sequentially increase the frame pointer FRMP by one and read the respective content of the memory area MEMC. For example, in order to read three parameters, the processing circuits increases three time the frame pointer FMRP, each time reading the respective memory content, as schematically shown via steps 5002, 5004 and 5006.

In the embodiment considered, the processing circuit 402 increase then at a step 5008 the value CNT by one and determines at a step 5010 whether the count value CNT corresponds to the down-sampling factor DSF.

In response to determining that the count value CNT corresponds to the down-sampling factor DSF (output “Y” of the verification step 5010), the processing circuit 402 resets at a step 5012 the count value CNT to zero, stores at a step 5016 the count value CNT again to the frame of configuration data FRM in the memory MEMC, and signals at a step 5018 the end of the processing operation, e.g., by asserting the respective acknowledge signal ACK.

Conversely, in response to determining that the count value CNT does not corresponds to the down-sampling factor DSF (output “N” of the verification step 5010), the processing circuit 402 sets at a step 5014 the frame pointer FRMP to the address RCODEP read from the frame of configuration data FRM, and then proceeds again to the step 5016.

Accordingly, when the count value CNT reaches the down-sampling factor DSF, the next processing operation of the processing chain CHN is executed. Conversely, when the count value CNT does not reach the down-sampling factor DSF, one or more of the following processing operations of the processing chain CHN may be skipped by jumping to the address RCODEP.

FIGS. 14C and 14D show an embodiment of the operation of the down-sampling operation. Specifically, in the embodiment considered, a processing chain CHN is started in response to a start-flag CTRL_A.

In the embodiment considered, the processing chain CHN comprises three processing operations PO1, PO2 and PO3. Specifically, the first processing operation specifies a low-pass filter function. Accordingly, the first operation PO1 may be specified by indicating the code RCODE_CONV followed by the respective frame of configuration data FRM indicating that given input data at an address INP_PO1 should be processed to generate output data to be stored to an address OUTP_PO1. The second processing operation PO2 specifies a down-sampling operation by 8 and the third processing operation PO3 extracts the module. For example, the module operation may be specified by indicated the respective code RCODE, e.g., RCODE_PO3, and the respective frame of configuration data FRM indicating that the data stored to the address OUT_PO1 should be processed, wherein the processed data should be stored to an address OUTP_PO3. For example, for a real numbers x, the module operation may provide the absolute value of the number, i.e., \sqrt{x²}=|x|.

In the embodiment considered, the processing chain CHN ends then with the end-code RCODE_END. Accordingly, in the embodiment considered, the processing operation PO3 should only be executed when the count value CNT of the processing operation PO2 reached the down-sampling factor of 8. Accordingly, in order to selectively skip the processing operation PO3, the processing operation PO2 may be specified by indicating the code RCODE_DS and a frame of configuration data comprising the count value CNT, the down-sampling factor DSF of 8, and as address RCODEP the address of the end-code RCODE_END.

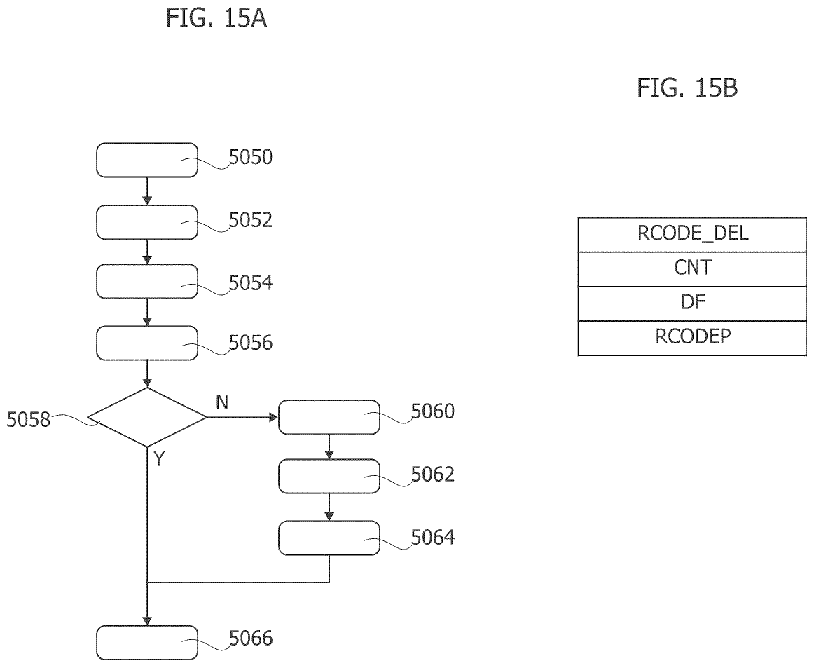

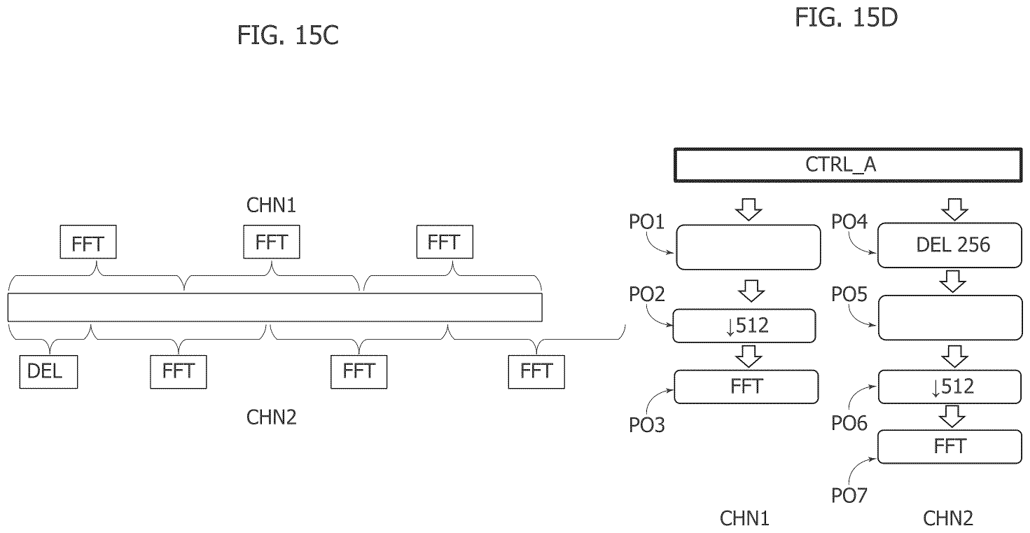

FIGS. 15A and 15B show a further embodiment of a chain-modifier processing circuit 402. Specifically, FIG. 15A shows an embodiment of the operation of a delay circuit 402 identified via a code RCODE_DEL, and FIG. 15B shows a respective frame of configuration data FRM.

Specifically, in the embodiment considered, in response to being enabled, e.g., in response to the respective request signal REQ, as schematically shown via a start step 5050, the processing circuit reads the frame of configuration data FRM. For example, in the embodiment shown in FIG. 15B, the frame of configuration data FRM comprises a count value CNT, a delay factor DF and the address of a next code RCODE. Accordingly, in order to read these data, the processing circuit 402 may sequentially increase the frame pointer FRMP by one and read the respective content of the memory area MEMC. For example, in order to read three parameters, the processing circuits increases three time the frame pointer FMRP, each time reading the respective memory content, as schematically shown via steps 5052, 5054 and 5056.

In the embodiment considered, the processing circuit 402 determines at a step 5058 whether the count value CNT is greater than the delay factor DF. In response to determining that the count value CNT is greater than the delay factor DF (output “Y” of the verification step 5058), the processing circuit 402 signals at a step 5066 the end of the processing operation, e.g., by asserting the respective acknowledge signal ACK.

Conversely, in response to determining that the count value CNT is not greater than the delay factor DF (output “N” of the verification step 5058), the processing circuit 402 increases at a step 5060 the count value CNT, stores at a step 5062 the count value CNT again to the frame of configuration data FRM in the memory MEMC. Moreover, the processing circuit 402 sets at a step 5064 the frame pointer FRMP to the address RCODEP read from the frame of configuration data FRM, and then proceeds again to the step 5066.

Accordingly, when the count value CNT reaches the delay factor DF, the next processing operation of the processing chain CHN is executed. Conversely, when the count value CNT is smaller than the delay factor DF, one or more following processing operation of the processing chain CHN may be skipped by jumping to the address RCODEP.

For example, FIGS. 15C and 15D show an embodiment of the use of the delay processing circuit. Specifically, in the embodiment considered, two processing chains CHN1 and CHN2 are started in response to a start-flag CTRL_A, e.g., indicative of the completion of an analog-to-digital conversion. For example, for this purpose the chain-handler memory area MEMCH may comprise a first mapping rule indicating that the first chain CHN1 should be processed in response to the start-flag CTRL_A, e.g., by specifying a first mask MASK1 having the corresponding flag asserted, wherein the first mask MASK1 is followed by the start address CHN1P of the first chain CHN1, and a second mapping rule indicating that the second chain CHN2 should be processed in response to the start-flag CTRL_A, e.g., by specifying a second mask MASK2 having the corresponding flag asserted, wherein the second mask MASK2 is followed by the start address CHN2P of the second chain CHN2.

In the embodiment considered, the first processing chain CHN1 comprises a first processing operation PO1 configured to obtain the sample from the analog-to-digital converter ADC and store the sample to a first buffer. Moreover, the first processing chain CHN1 comprises a second processing operation PO2, corresponding to a down-sampling by a rate of 512, followed by a third processing operation PO3 starting an FFT processing circuit configured to process the data stored to the first buffer. Accordingly, in the embodiment considered, the FFT processing circuit is started each time 512 samples have been transferred to the first buffer.

Conversely, in the embodiment considered, the second processing chain CHN2 comprises a processing operation PO5 configured to obtain the sample from the analog-to-digital converter ADC and store the sample to a second buffer. Moreover, the second processing chain CHN2 comprises a processing operation PO6, corresponding to a down-sampling by a rate of 512, followed by a processing operation PO7 starting the FFT processing circuit configured to process the data stored to the second buffer. Accordingly, in the embodiment considered, the FFT processing circuit is started each time 512 samples have been transferred to the second buffer.

However, in the embodiment considered, the second processing chain CHN2 also comprises an initial processing operation PO4 corresponding to a delay operation of 256, whereby the FFT operations of the first processing chain CHN1 and the second processing chain CHN2 are shifted by 256 samples.

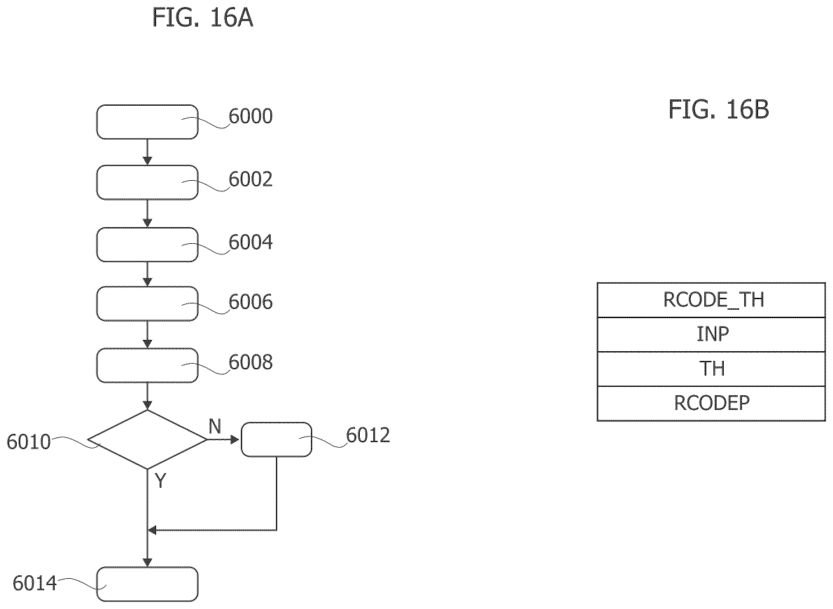

FIGS. 16A and 16B show a further embodiment of a chain-modifier processing circuit 402. Specifically, FIG. 16A shows an embodiment of the operation of a threshold comparison circuit 402 identified via a code RCODE_TH, and FIG. 16B shows a respective frame of configuration data FRM.

Specifically, in the embodiment considered, in response to being enabled, e.g., in response to the respective request signal REQ, as schematically shown via a start step 6000, the processing circuit 402 reads the frame of configuration data FRM. For example, in the embodiment shown in FIG. 16B, the frame of configuration data FRM comprises a pointer INP to input data, a threshold value TH and the address RCODEP of a next code RCODE. For example, in order to read these data, the processing circuit 402 may sequentially increase the frame pointer FRMP by one and read the respective content of the memory area MEMC. For example, in order to read three parameters, the processing circuits increases three time the frame pointer FMRP, each time reading the respective memory content, as schematically shown via steps 6002, 6004 and 6006. Moreover, in order to obtain the actual input data, DATA_IN, the processing circuits reads at a step 6008 the data stored to the address INP.

In the embodiment considered, the processing circuit 402 determines at a step 6010 whether the input data DATA_IN are greater than the threshold TH. In response to determining that the input data DATA_IN are greater than the threshold TH (output “Y” of the verification step 6010), the processing circuit 402 signals at a step 6014 the end of the processing operation, e.g., by asserting the respective acknowledge signal ACK.

Conversely, in response to determining that the input data DATA_IN are not greater than the threshold TH (output “N” of the verification step 6010), the processing circuit 402 sets at a step 6012 the frame pointer FRMP to the address RCODEP read from the frame of configuration data FRM, and then proceeds again to the step 6018.

Accordingly, when the input data DATA_IN are greater than the threshold TH, the next processing operation of the processing chain CHN is executed. Conversely, when the input data DATA_IN are not greater than the threshold TH, one or more next processing operations of the processing chain CHN may be skipped by jumping to the address RCODEP. A complementary operation may also be implemented by determining at the step 6014 whether the input data DATA_IN are smaller than the threshold TH, i.e., one or more next processing operation of the processing chain CHN may be skipped by jumping to the address RCODEP in response to determining that the input data DATA_IN are greater than the threshold TH.

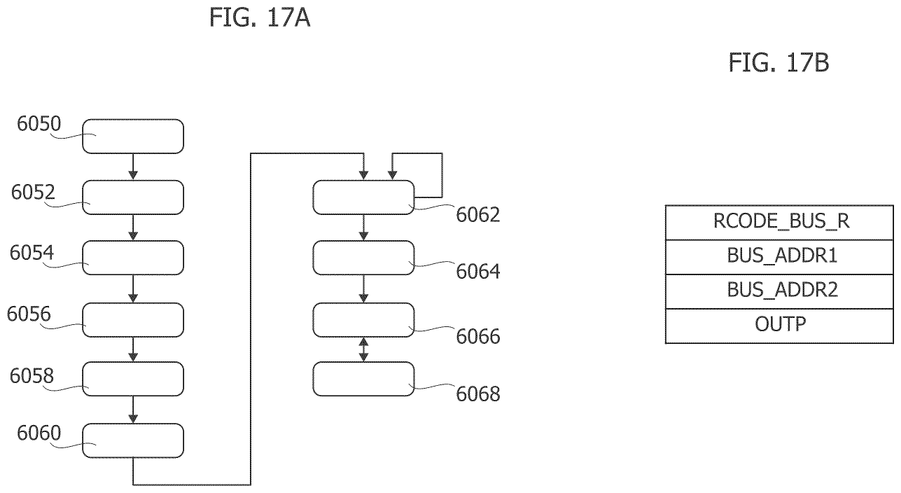

FIGS. 17A and 17B show an embodiment of a support processing circuit 402. Specifically, FIG. 17A shows an embodiment of the operation of read interface for the communication system 114 identified via a code RCODE_BUS_R, and FIG. 16B shows a respective frame of configuration data FRM.

Specifically, in the embodiment considered, in response to being enabled, e.g., in response to the respective request signal REQ, as schematically shown via a start step 6050, the processing circuit reads the frame of configuration data FRM. For example, in the embodiment shown in FIG. 17B, the frame of configuration data FRM comprises one or more fields BUS_ADDR comprising an address of the communication system 114, such as a first field BUS_ADDR1 comprising a first set of bits and second field BUS_ADDR2 comprising a second set of bits, and a target address OUTP for the data received from the communication system 114. For example, in order to read these data, the processing circuit 402 may sequentially increase the frame pointer FRMP by one and read the respective content of the memory area MEMC. For example, in order to read three parameters, the processing circuits increases three time the frame pointer FMRP, each time reading the respective memory content, as schematically shown via steps 6052, 6054 and 6056.

Next, the processing circuit generates at a step 6058 a read request comprising the address data BUS_ADDR, e.g., BUS_ADDR1 and BUS_ADDR2, and sends at a step 6060 the read request to the communication system 114. Next, the processing circuit 402 waits at a step 6062 until a response is received from the communication system 114. In response to receiving the response, the processing circuit 402 extracts at a step 6064 the response data from the response, stores the extracted response data to the memory location indicated by the memory address OUTP and signals at a step 6068 the end of the processing operation, e.g., by asserting the respective acknowledge signal ACK.

For example, the processing circuit of FIG. 17A may be used to obtain a sample from an analog-to-digital converter ADC, as described with respect to the processing operations PO1 and PO4 of FIG. 15D.

Similarly, a processing circuit 402 may be configured as write interface for the communication circuit 402. For example, in this case, the frame of configuration data FRM may comprise an address INP for input data, and the processing circuit 402 may be configured to read the data from the address INP, generate a write request comprising the data read from the address INP and the address data BUS_ADDR included in the frame of configuration data FRM, e.g., BUS_ADDR1 and BUS_ADDR2, and send the write request to the communication system 114.

Accordingly, the above-described co-processors 40 permit to configure one or more processing chains CHN, wherein each processing chain CHN may comprise one or more processing operations PO. Specifically, each processing operation PO indicates via the code RCODE a respective processing circuit 402 and via the frame of configuration data FRM the respective parameters to be used by the processing circuit 402. This also permits the switch easily between different sets of configuration data to be used by the same processing circuit 402.

Specifically, in the embodiments considered, the co-processor 40 comprises a plurality of processing circuits 402, a first memory 404 a second memory 406 and an FSM 400. In various embodiments, the first memory 404 is configured to store control data CTRL. Conversely, the second memory 406 comprising a memory area MEMC for storing a chain frame CHN specifying a sequence of one or more processing operations PO.

Specifically, in the embodiments considered in the foregoing, each processing operation PO has associated data comprising a code RCODE indicating one of the processing circuits 402 followed by a frame of configuration data FRM comprising configuration data to be used for the processing operation.

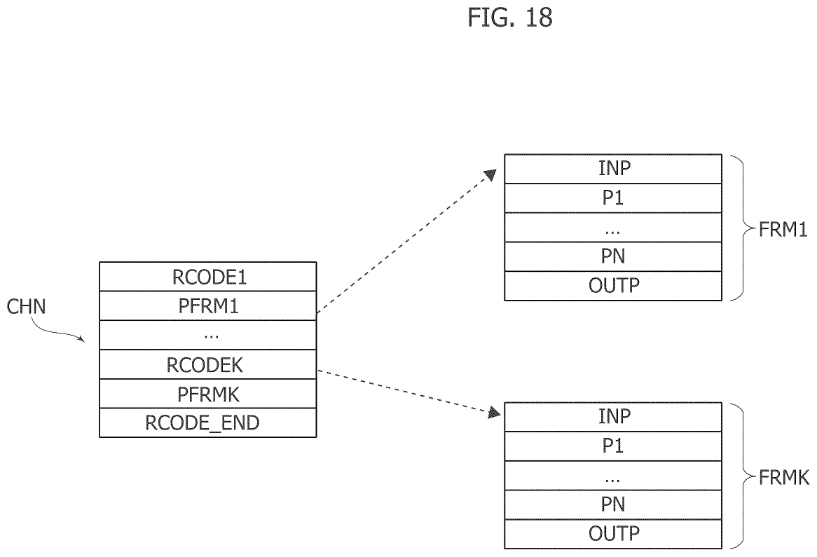

Conversely, FIG. 18 shows a further embodiment of the data associated with the processing operations. Specifically, in the embodiment considered, each processing operation PO has associated data comprising a code RCODE indicating one of the processing circuits 402 followed by a configuration frame pointer PFRM, e.g., a pointer PFRM1 for the code RCODE1 and a pointer PFRMK for a code RCODEK. Specifically, each configuration frame pointer PFRM indicates the (e.g., start) address of a respective frame of configuration data FRM, e.g., the configuration frame pointer PFRM1 may indicate the start address of a frame of configuration data FRM1 and the configuration frame pointer PFRMK may indicate the start address of a frame of configuration data FRMK. For example, in this case, the frame of configuration data FRM may be stored to the memory area MEMC or another memory area within the memory 406. Accordingly, in the embodiment considered, the enabled processing circuit 402 first reads the configuration frame pointer PFRM as indicated via the frame pointer FRMP, and then the frame of configuration data FRM indicated by the configuration frame pointer PFRM.

In various embodiments, the solutions may also be combined, e.g., a code RCODE may be followed either by a frame of configuration data FRM or by a configuration frame pointer PFRM indicating in turn the address of a respective frame of configuration data FRM. For example, the embodiment shown in FIG. 18 may be advantageously in case the same frame of configuration data FRM should be used for plural processing operations of the same chain CHN, because the configuration frame pointer PFRM of two processing operations PO may also point to the address of the frame of configuration data FRM.

Accordingly, in response to being enabled, each processing circuit 402 is configured to obtain a frame pointer FRMP indicating the position of the data associated with a processing operation PO within the memory area MEMC, and read the configuration data of the frame of configuration data FRM associated with the processing operation from the second memory 406, e.g., based on the frame pointer FRMP. As mentioned before, the frame pointer FRMP may indicate directly the frame of configuration data FRM or a configuration frame pointer PFRM indicating in turn the frame of configuration data FRM.

In various embodiments, the processing circuit 402 varies the frame pointer FRMP to indicate the position of data associated with a next processing operation PO. For example, in various embodiments, the processing circuit 402 increase the frame pointer FRMP based on the length of the frame of configuration data FRM. However, in the embodiment shown in FIG. 18, the processing circuit 402 may simply increase the frame pointer FRMP by one, or the increase may be performed by the FSM 400. In various embodiments, the processing circuit 402 may vary the frame pointer FRMP also in order to implement a jump operation. Such an operation may be implemented also in the embodiment shown in FIG. 18, because the conditioned pointer address RCODEP is included in the frame of configuration data FRM.

Accordingly, the enabled processing circuit 402 is configured to execute a processing operation PO as a function of the configuration data read from the memory area MEMC and, in response to having completed the processing operation, signal the completion of the processing operation.

Conversely, the FSM 400 is configured to monitor the control data CTRL in order to determine whether the chain frame CHN should be processed. In response to determining that the chain frame CHN should be processed, the FSM 400 obtains, e.g., via the steps 4004-4014, a chain start-address, e.g., SCHN or CHN1P, indicating the start address of the chain frame CHN, and sets, e.g., via the step 4016, the frame pointer FRMP to the start-address of the chain frame.

Next, the FSM 400 reads, e.g., via step 4018, a code associated with a processing operation PO from the first memory area MEMC based on the frame pointer FRMP, and determines, e.g., via step 4020, whether the code read from the memory area MEMC corresponds to a code RCODE indicating one of the processing circuits 402. In various embodiments the FSM 400 may also determine whether the code read from the memory area MEMC corresponds to the code RCODE_END indicating the end of the chain frame CHN.

Accordingly, in response to determining that the code read from the memory area MEMC corresponds to a code RCODE indicating one of the processing circuits 402, the FSM 400 enables, e.g., via step 4022, the processing circuit 402 indicated by the code RCODE read from the memory area MEMC, whereby the enabled processing circuit 402 executes the respective processing operation. As mentioned before, in various embodiments, the enabled processing circuit 402 may also update the frame pointer FRMP to indicate a next processing operation PO, e.g., by increasing the frame pointer FRMP or setting the frame pointer FRMP to a new address RCODEP.

Accordingly, once the enabled processing circuit 402 signals the completion of the processing operation, and in case several processing operations PO should be executed, the FSM 400 may analyze the next code RCODE. Conversely, e.g., in response to determining that the code read from the first memory area MEMC corresponds to the code RCODE_END or when a given number of processing operations has been executed, the FSM 400 signals, e.g., via step 4036, the end of the processing of the chain frame CHN.

Of course, without prejudice to the principle of the invention, the details of construction and the embodiments may vary widely with respect to what has been described and illustrated herein purely by way of example, without thereby departing from the scope of the present invention, as defined by the ensuing claims.

What is claimed is:

1. A co-processor comprising:
a plurality of processing circuits;
a first memory configured to store control data;
a second memory comprising a first memory area for storing a chain frame specifying a sequence of one or more processing operations, wherein each processing operation has associated data comprising a code indicating one of the processing circuits and a configuration data frame comprising configuration data to be used for the respective processing operation; and
a finite-state machine (FSM) configured to, in response to the control data indicating that the chain frame should be processed, enable a respective processing circuit indicated by a first code in the chain frame;
wherein each processing circuit is configured to, in response to being enabled:
read the configuration data of the configuration data frame associated with the respective processing operation from the second memory; and
execute the respective processing operation as a function of the configuration data read from the first memory area.

2. The co-processor of claim 1, wherein the FSM is configured to, in response to the control data indicating that the chain frame should be processed:
a) obtain a chain start-address indicating a start-address of the chain frame;
b) set a chain frame pointer to the start-address of the chain frame;
c) read the first code from the first memory area based on the chain frame pointer;
d) determine whether the first code read from the first memory area corresponds to one of the codes indicating one of the processing circuits; and
e) in response to determining that the first code read from the first memory area corresponds to the one of the codes indicating the one of the processing circuits, enable the respective processing circuit indicated by the first code.

3. The co-processor of claim 2, wherein each processing operation has associated data comprising the code indicating one of the processing circuits followed by the configuration data frame, and wherein the enabled processing circuit is configured to:
obtain the chain frame pointer indicating a position of the data associated with a processing operation within the second memory;
read the configuration data of the configuration data frame associated with the processing operation from the second memory based on the chain frame pointer; and
increase the chain frame pointer to indicate a position of data associated with a next processing operation based on a length of the configuration data frame.

4. The co-processor of claim 3,
wherein the FSM is configured to read the first code from the first memory area based on the chain frame pointer by:
reading the first code from a memory location indicated by the chain frame pointer; and
increasing the chain frame pointer to indicate a start of a following configuration data frame; and
wherein each processing circuit is configured to read the configuration data of the configuration data frame associated with the processing operation from the first memory area based on the chain frame pointer by:
reading the configuration data of the configuration data frame from the first memory area starting from the memory location indicated by the chain frame pointer.

5. The co-processor of claim 3,
wherein each processing circuit is configured to increase the chain frame pointer to indicate the position of the data associated with the next processing operation based on the length of the configuration data frame by setting the chain frame pointer to an address of a last memory location of the configuration data frame; and
wherein the FSM is configured to increase the chain frame pointer by one and return to step c).

6. The co-processor of claim 3, wherein each processing circuit is configured to increase the chain frame pointer to indicate the position of the data associated with the next processing operation based on the length of the configuration data frame by setting the chain frame pointer to an address of a last memory location of the configuration data frame plus one; and
wherein the FSM is configured to return to step c).

7. The co-processor of claim 2, wherein each processing operation has associated data comprising the code indicating one of the processing circuits followed by a configuration frame pointer indicating a memory address of the configuration data frame and wherein the enabled processing circuit is configured to:
obtain the chain frame pointer indicating a position of the data associated with a processing operation within the second memory;
read the configuration frame pointer associated with the processing operation from the second memory based on the chain frame pointer; and
read the configuration data of the configuration data frame associated with the processing operation from the second memory based on the configuration frame pointer.

8. The co-processor of claim 1,
wherein each processing circuit is configured to:
in response to having completed the respective processing operation, signal a completion of the respective processing operation; and
wherein the FSM is configured to:
e) in response to determining that the first code read from the first memory area corresponds to one of the codes indicating one of the processing circuits:
wait until the enabled processing circuit signals the completion of the respective processing operation.

9. The co-processor of claim 2, wherein the chain frame ends with a code indicating an end of the chain frame, and wherein the FSM is configured to:
determine whether the first code read from the first memory area corresponds to one of the codes indicating one of the processing circuits, the code indicating one of the processing circuits also indicating the end of the chain frame;
in response to determining that the first code read from the first memory area corresponds to one of the codes indicating one of the processing circuits:
in response to detecting that the enabled processing circuit signals a completion of the respective processing operation, return to step c); and
in response to determining that the first code read from the first memory area corresponds to the code indicating the end of the chain frame, signal an end of processing of the chain frame.

10. The co-processor of claim 2, wherein the first memory area of the second memory is configured to store a first chain frame and a second chain frame, and a second memory area of the second memory is configured to store a first start-address of the first chain frame and a second start-address of the second chain frame, and wherein the FSM is configured to:
monitor the control data to determine whether the first chain frame or the second chain frame should be processed;
in response to determining that the first chain frame should be processed, read the first start-address of the first chain frame from the second memory area and set the chain frame pointer to the first start-address of the first chain frame; and
in response to determining that the second chain frame should be processed, read the second start-address of the second chain frame from the second memory area and set the chain frame pointer to the second start-address of the second chain frame.

11. The co-processor of claim 10, wherein the second memory area is configured to store a first mapping rule indicating whether a given chain frame should be processed, wherein the first mapping rule is followed by a start-address of the given chain frame corresponding to the first start-address of the first chain frame when the given chain frame corresponds to the first chain frame or the second start-address of the second chain frame when the given chain frame corresponds to the second chain frame, and wherein the FSM is configured to:
read the first mapping rule from the second memory area;
determine whether the first mapping rule and the control data indicate that the given chain frame should be processed;
in response to determining that the given chain frame should be processed, read the start-address of the given chain frame from the second memory area; and
set the chain frame pointer to the start-address of the given chain frame.

12. The co-processor of claim 1, wherein the plurality of processing circuits comprise one or more digital processing circuits configured to process data stored to a first memory location indicated via a first address and store the processed data to a second memory location indicated via a second address, wherein the configuration data frame read by the one or more digital processing circuits comprises the first address and the second address.

13. The co-processor of claim 12, wherein the one or more digital processing circuits is configured to implement: a Fast Fourier Transform, a Finite-Impulse Response filter, an Artificial Neural Network or a cryptographic processing circuit.

14. The co-processor of claim 2, wherein the plurality of processing circuits comprise one or more chain-modifier circuits configured to read the configuration data frame comprising an address of a next code, and selectively set the chain frame pointer to the address of the next code.

15. The co-processor of claim 14, wherein the one or more chain-modifier circuits is configured to implement a down-sampling function, a delay function or a threshold comparison operation.

16. The co-processor of claim 1, wherein the plurality of processing circuits comprise one or more support circuits configured to:
transfer data between the second memory and a memory external with respect to the co-processor; and/or
send read and/or write request to a communication system; and/or
request the execution of a given operation via a circuit external with respect to the co-processor and wait until the circuit signals a completion of the given operation.

17. A processing system comprising:
a processing core;
a communication system connecting a co-processor to the processing core; and
the co-processor, comprising:
a plurality of processing circuits;
a first memory configured to store control data;
a second memory comprising a first memory area for storing a chain frame specifying a sequence of one or more processing operations, wherein each processing operation has associated data comprising a code indicating one of the processing circuits and a configuration data frame comprising configuration data to be used for the respective processing operation; and
a finite-state machine (FSM) configured to, in response to the control data indicating that the chain frame should be processed, enable a respective processing circuit indicated by a first code in the chain frame;
wherein each processing circuit is configured to, in response to being enabled:
read the configuration data of the configuration data frame associated with the respective processing operation from the second memory; and
execute the respective processing operation as a function of the configuration data read from the first memory area.

18. The processing system of claim 17, wherein the FSM is configured to, in response to the control data indicating that the chain frame should be processed:
a) obtain a chain start-address indicating a start-address of the chain frame;
b) set a chain frame pointer to the start-address of the chain frame;
c) read the first code from the first memory area based on the chain frame pointer;
d) determine whether the first code read from the first memory area corresponds to one of the codes indicating one of the processing circuits; and
e) in response to determining that the first code read from the first memory area corresponds to the one of the codes indicating the one of the processing circuits, enable the respective processing circuit indicated by the first code.

19. The processing system of claim 17, wherein the processing system is disposed on an integrated circuit.

20. A method of operating a co-processor comprising a plurality of processing circuits, a first memory, a second memory comprising a first memory area, and a finite-state machine (FSM); the method comprising:
storing a chain frame to the first memory area of the second memory, the chain frame specifying a sequence of one or more processing operations, data associated with each processing operation comprising a code indicating one of the processing circuits and a configuration data frame comprising configuration data to be used for the processing operation, the chain frame ending with a code indicating the end of the chain frame; and
setting, by the FSM, control data in the first memory to indicate that the chain frame should be processed by the co-processor.

21. The method of claim 20, further comprising:
reading, by each processing circuit that is enabled, the configuration data of the configuration data frame associated with the processing operation from the second memory; and
executing, by each processing circuit that is enabled, the processing operation as a function of the configuration data read from the first memory area.

22. The method of claim 21, further comprising, in response to the FSM setting the control data to indicate that the chain frame should be processed by the co-processor:
a) obtaining, by the FSM, a chain start-address indicating a start-address of the chain frame;
b) setting, by the FSM, a chain frame pointer to the start-address of the chain frame;
c) reading, by the FSM, a first code from the first memory area based on the chain frame pointer;
d) determining, by the FSM, whether the first code read from the first memory area corresponds to one of the codes indicating one of the processing circuits; and
e) in response to determining that the first code read from the first memory area corresponds to one of the codes indicating one of the processing circuits, enabling, by the FSM, the processing circuit indicated by the first code read from the first memory area, so that the enabled processing circuit executes the respective processing operation.
